(19) United States
(12) Patent Application Publication
(10) Pub. No.: US 2024/0007410 A1
(43) Pub. Date: Jan. 4, 2024

(54) PACKET TRANSMISSION AND RECEPTION IN A WIRELESS COMMUNICATION NETWORK

(71) Applicant: Telefonaktiebolaget LM Ericsson (PUBL), Stockholm (SE)

(72) Inventors: Richard Tano, STOCKHOLM (SE); Du Ho Kang, Sollentuna (SE); Jose Luis Pradas, STOCKHOLM (SE)

(21) Appl. No.: 18/247,385

(22) PCT Filed: Oct. 13, 2021
(86) PCT No.: PCT/SE2021/051004

§ 371 Date: Mar. 30, 2023

Related U.S. Application Data
(60) Provisional application No. 63/092,816, filed on Oct. 16, 2020.

(51) Int. Cl. H04L 47/34; H04L 47/32

(52) U.S. Cl. CPC H04L 47/34; H04L 47/32

(57) ABSTRACT

A receiver (16) is configured for use in a wireless communication network. The receiver (16) waits to receive one or more packets (14-X) from a transmitter (12). The receiver (16) receives, from the transmitter (12), signaling (22) indicating that the receiver (16) is to consider the one or more packets (14-X) as discarded, not expect the one or more packets (14-X), consider the one or more packets (14-X) as delivered to an upper layer, or consider the one or more packets (14-X) as received. Responsive to receiving the signaling (22), the receiver (16) stops waiting to receive the one or more packets (14-X).

### TECHNICAL FIELD

The present application relates generally to a wireless communication network, and relates more particularly to packet transmission and reception in such a network.

### BACKGROUND

A transmitter typically segments data to be transmitted into packets that are re-assembled at the receiver. Such segmentation may for instance be performed at a Packet Data Convergence Protocol (PDCP) layer in a wireless communication network. Regardless, the transmitter orders the packets into a sequence and assigns respective sequence numbers to the packets for in-sequence transmission to the receiver.

Outside factors such as non-ideal radio conditions or the sending of packets through different lower layer pathways may cause the packets to reach the receiver out of order and/or for some packets to be dropped. The receiver accordingly keeps track of which packets have been received and re-orders the packets according to the sequence numbers. In this regard, the receiver detects when a gap occurs in the sequence numbering of the received packets, suggesting that some packets have been received out of order and that there are some packets with intermediate sequence numbers still missing at the receiver. The receiver waits for some time in anticipation that it will receive the missing packet(s). If the missing packet(s) are received within this time, the receiver re-orders the received packets for in-sequence delivery, e.g., to a higher layer. If the missing packet(s) are not received within this time, though, the receiver may consider the packets as having been lost.

Although reordering functionality at the receiver ensures in-sequence packet delivery, waiting for packets to be received out-of-sequence jeopardizes any latency requirements imposed on the data transmission, e.g., as may be the case for eXtended Reality (XR) traffic. If the latency requirements are fairly strict, waiting on missing packets may be pointless as the packets would be useless to a higher layer anyway. Even if the latency requirements are not as strict, the delay attributable to reordering may make packets that the receiver has already received, albeit out of order, useless at a higher layer.

### SUMMARY

According to some embodiments herein, a transmitter sends signaling to a receiver so that the receiver can know if and/or when to stop waiting for missing packet(s), e.g., at a PDCP layer. The signaling may for instance indicate that the receiver is to not expect one or more packets, or that the receiver is to consider one or more packets as discarded, as received, and/or as delivered to an upper layer. The signaling may thereby prompt the receiver to stop waiting for those one or more packets. For example, if the receiver is waiting to receive packets within a reordering window, receipt of signaling indicating that the receiver should not expect to receive those packets may prompt the receiver to stop waiting for them. Rather than naively continuing to wait for a reordering timer to expire, then, the receiver may stop waiting to receive packet(s) within the reordering window even before the reordering timer expires. This may in turn reduce the delay attributable to packet reordering and thereby improve compliance with latency requirements.

More particularly, embodiments herein include a method performed by a receiver configured for use in a wireless communication network. The method comprises waiting to receive one or more packets from a transmitter. The method further comprises receiving, from the transmitter, signaling indicating that the receiver is to consider the one or more packets as discarded, not expect the one or more packets, consider the one or more packets as delivered to an upper layer, or consider the one or more packets as received. The method also comprises, responsive to receiving the signaling, stopping waiting to receive the one or more packets.

In some embodiments, the signaling indicates which one or more packets are to be considered as discarded, not expected, considered as delivered to an upper layer, or considered as received by explicitly indicating each of one or more respective sequence numbers of the one or more packets. In other embodiments, the signaling indicates which one or more packets are to be considered as discarded, not expected, considered as delivered to an upper layer, or considered as received by explicitly indicating a sequence number of a packet having the highest sequence number among one or more respective sequence numbers of the one or more packets that are to be considered as discarded, not expected, considered as delivered to an upper layer, or considered as received.

In some embodiments, the signaling is included in a data packet with a sequence number, wherein the receiver is to consider as discarded, not expect, consider as delivered to an upper layer, or consider as received each packet that has a sequence number less than the sequence number of the data packet.

In some embodiments, the signaling does not explicitly indicate which one or more packets are to be considered as discarded, not expected, considered as delivered to an upper layer, or considered as received. In one such embodiment, the receiver is to consider as discarded, not expect, consider as delivered to an upper layer, or consider as received each packet that, as of receipt of the signaling, is within a reordering window of the receiver.

In some embodiments, the transmitter is a Packet Data Convergence Protocol, PDCP, transmitter, the receiver is a PDCP receiver, and the one or more packets are one or more PDCP packets.

In some embodiments, the signaling is or is included in a PDCP packet.

In some embodiments, the signaling is or is included in a PDCP control protocol data unit, PDU, and the PDCP control PDU is a type of PDCP control PDU dedicated or specific for indicating that the receiver is to consider the one or more packets as discarded, not expect the one or more packets, consider the one or more packets as delivered to an upper layer, or consider the one or more packets as received.

In some embodiments, the signaling is or is included in a PDCP data PDU. In one embodiment, the PDCP data PDU includes a field that indicates the receiver is to consider the one or more packets as discarded, not expect the one or more packets, consider the one or more packets as delivered to an upper layer, or consider the one or more packets as received. In another embodiment, the PDCP data PDU includes a field that indicates whether one or more sequence numbers indicated by the PDCP data PDU are one or more respective sequence numbers of one or more packets that the receiver is to consider as discarded, not expect, consider as delivered to an upper layer, or consider as received.

In some embodiments, the method further comprises, based on the signaling, considering the one or more packets as discarded, as delivered to an upper layer, or as received.

In some embodiments, the method further comprises, based on the signaling, updating one or more parameters at the receiver to reflect that the one or more packets are not expected, that the one or more packets have been received, that the one or more packets have been discarded, and/or that the one or more packets have been delivered to an upper layer. In one embodiment, for example, the one or more parameters include an RX_DELIV parameter indicating a sequence number of a next packet to be delivered to an upper layer.

In some embodiments, the method further comprises, based on the signaling, updating a reordering window at the receiver.

In some embodiments, said waiting comprises waiting to receive the one or more packets while a reordering timer is running. In one such embodiment, said stopping comprises, responsive to receiving the signaling while the reordering timer is running, stopping waiting to receive the one or more packets before the reordering timer expires.

Embodiments herein further include a method performed by a transmitter configured for use in a wireless communication network. The method comprises transmitting, to a receiver, signaling indicating that the receiver is to consider one or more packets as discarded, not expect one or more packets, consider one or more packets as delivered to an upper layer, or consider one or more packets as received.

In some embodiments, the signaling is included in a data packet with a sequence number, and the receiver is to consider as discarded, not expect, consider as delivered to an upper layer, or consider as received each packet that has a sequence number less than the sequence number of the data packet.

In some embodiments, the signaling does not explicitly indicate which one or more packets are to be considered as discarded, not expected, considered as delivered to an upper layer, or considered as received. In one such embodiment, the receiver is to consider as discarded, not expect, consider as delivered to an upper layer, or consider as received each packet that, as of receipt of the signaling, is within a reordering window of the receiver.

In some embodiments, the transmitter is a Packet Data Convergence Protocol, PDCP, transmitter, the receiver is a PDCP receiver, and the one or more packets are one or more PDCP packets.

In some embodiments, the signaling is or is included in a PDCP packet.

In some embodiments, the signaling is or is included in a PDCP control protocol data unit, PDU, and the PDCP control PDU is a type of PDCP control PDU dedicated or specific for indicating that the receiver is to consider the one or more packets as discarded, not expect the one or more packets, consider the one or more packets as delivered to an upper layer, or consider the one or more packets as received.

In some embodiments, the signaling is or is included in a PDCP data PDU. In one embodiment, the PDCP data PDU includes a field that indicates the receiver is to consider the one or more packets as discarded, not expect the one or more packets, consider the one or more packets as delivered to an upper layer, or consider the one or more packets as received. In another embodiment, the PDCP data PDU includes a field that indicates whether one or more sequence numbers indicated by the PDCP data PDU are one or more respective sequence numbers of one or more packets that the receiver is to consider as discarded, not expect, consider as delivered to an upper layer, or consider as received.

In some embodiments, the method further comprises deciding that the receiver is to consider the one or more packets as discarded, not expect the one or more packets, consider the one or more packets as delivered to an upper layer, or consider the one or more packets as received, and wherein said transmitting is performed based on said deciding.

In some embodiments, the method further comprises making a decision as to whether or not to transmit the signaling. In one such embodiment, the method further comprises estimating a delay until a packet would be or will be received by the receiver, the decision is made based on the estimated delay, the delay is a delay until the packet would be or will be received at a PDCP layer or an application layer at the receiver, and making the decision comprises making the decision to transmit the signaling if the estimated delay exceeds a threshold.

Embodiments herein include corresponding apparatus, computer programs, and carriers of those computer programs. For example, embodiments herein include a receiver configured for use in a wireless communication network. The receiver is configured to wait to receive one or more packets from a transmitter. The receiver is also configured to receive, from the transmitter, signaling indicating that the receiver is to consider the one or more packets as discarded, not expect the one or more packets, consider the one or more packets as delivered to an upper layer, or consider the one or more packets as received. The receiver is further configured to, responsive to receiving the signaling, stop waiting to receive the one or more packets.

Embodiments herein also include a transmitter configured for use in a wireless communication network. The transmitted is configured to transmit, to a receiver, signaling indicating that the receiver is to consider one or more packets as discarded, not expect one or more packets, consider one or more packets as delivered to an upper layer, or consider one or more packets as received.

Embodiments herein further include a computer program comprising instructions which, when executed by at least one processor of a transmitter, causes the transmitter to perform as described above. Embodiments also include a computer program comprising instructions which, when executed by at least one processor of a receiver, causes the receiver to perform as described above. Embodiments moreover include a carrier containing the computer program according to any of the above embodiments, wherein the carrier is one of an electronic signal, optical signal, radio signal, or computer readable storage medium.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a transmitter and a receiver according to some embodiments.

FIG. 2A is a block diagram of signaling in the form of a PDCP Control PDU according to some embodiments.

FIG. 2B is a block diagram of the starting state of a first example with 2 PDUs received in a PDCP receiver.

FIG. 2C is a block diagram of a PDCP transmitter transmitting a PDCP Control PDU, with PDU Type PDCP Discard, to the PDCP receiver in the first example.

FIG. 2D is a block diagram of the result in the first example after explicit discard indication through a PDCP Control PDU with PDU Type PDCP Discard.

FIG. 2E is a block diagram of the starting state of a second example with no PDUs received in a PDCP receiver.

FIG. 2F is a block diagram of a PDCP transmitter transmitting a PDCP Control PDU, with PDU Type PDCP Discard, to the PDCP receiver in the second example.

FIG. 2G is a block diagram of the result in the second example after explicit discard indication through a PDCP Control PDU with PDU Type PDCP Discard.

FIG. 2H is a block diagram of signaling in the form of a PDCP Data PDU according to some embodiments.

FIG. 3A is a block diagram of the starting state of a third example with 2 PDUs received in a PDCP receiver.

FIG. 3B is a block diagram of a PDCP transmitter transmitting a PDCP Control PDU, with PDU Type PDCP Discard, to the PDCP receiver in the third example.

FIG. 3C is a block diagram of the result in the third example after explicit discard indication through a PDCP Control PDU with PDU Type PDCP Discard.

FIG. 4 is a block diagram of signaling in the form of a Discard bit field in a PDCP Data PDU according to some embodiments.

FIG. 5A is a block diagram of the starting state of a fourth example with 2 PDUs received in a PDCP receiver.

FIG. 5B is a block diagram of a PDCP transmitter transmitting a PDCP Data PDU to the PDCP receiver in the fourth example.

FIG. 5C is a block diagram of the result in the fourth example after implicit discard indication through a PDCP Data PDU.

FIG. 5D is a block diagram of the starting state of a fifth example with no PDUs received in a PDCP receiver.

FIG. 5E is a block diagram of a PDCP transmitter transmitting a PDCP Data PDU to the PDCP receiver in the fifth example.

FIG. 5F is a block diagram of the result in the fifth example after implicit discard indication through a PDCP Data PDU.

FIG. 6 is a block diagram of signaling in the form of a PDCP Control PDU according to other embodiments.

FIG. 6A is a block diagram of the starting state of a sixth example with 2 PDUs received in a PDCP receiver.

FIG. 6B is a block diagram of a PDCP transmitter transmitting a PDCP Control PDU to the PDCP receiver in the sixth example.

FIG. 6C is a block diagram of the result in the sixth example after implicit discard indication through a PDCP Control PDU.

FIG. 7 is a line graph of frame latency measured over a radio access network (RAN).

FIG. 8 is a line graph of cumulative distribution functions of the number of transport blocks required to deliver a video frame with size ranging from 20 KB to 300 KB.

FIG. 9 is a logic flow diagram of a method performed by a transmitter according to some embodiments.

FIG. 10 is a logic flow diagram of a method performed by a receiver according to some embodiments.

FIG. 11 is a block diagram of a transmitter according to some embodiments.

FIG. 12 is a block diagram of a receiver according to some embodiments.

FIG. 13 is a block diagram of a wireless communication network according to some embodiments.

FIG. 14 is a block diagram of a user equipment according to some embodiments.

FIG. 15 is a block diagram of a virtualization environment according to some embodiments.

FIG. 16 is a block diagram of a communication network with a host computer according to some embodiments.

FIG. 17 is a block diagram of a host computer according to some embodiments.

FIG. 18 is a flowchart illustrating a method implemented in a communication system, in accordance with one embodiment.

FIG. 19 is a flowchart illustrating a method implemented in a communication system, in accordance with one embodiment.

FIG. 20 is a flowchart illustrating a method implemented in a communication system, in accordance with one embodiment.

FIG. 21 is a flowchart illustrating a method implemented in a communication system, in accordance with one embodiment.

### DETAILED DESCRIPTION

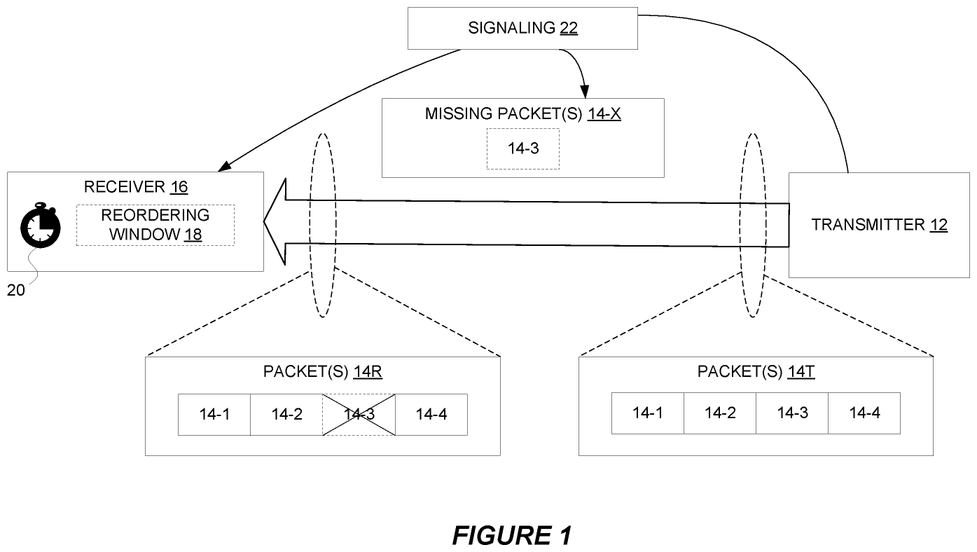

As shown in FIG. 1, a transmitter 12 transmits packet(s) 14T to a receiver 16. The transmitted packet(s) 14T may be packet(s) at a certain layer of a protocol stack implemented by the transmitter 12 and/or receiver 16. For example, the transmitted packet(s) 14T may be packet(s) at a Packet Data Convergence Protocol (PDCP) layer, e.g., such that the packet(s) 14T may be PDCP service data unit(s) (SDUs) or PDCP protocol data unit(s) (PDUs).

In some embodiments, the transmitter 12 transmits the packets 14T in a sequence. The transmitter 12 may for instance assign respective sequence numbers 14-1, 14-2, . . . 14-N to the packet(s) 14T and transmit the packet(s) 14T in sequential order according to those sequence numbers. The transmitter 12 in some embodiments includes the sequence number of a packet in a field of the packet, e.g., within a header of the packet. FIG. 1 shows as an example that the transmitter 12 may transmit four packets 14T with the sequence numbers 14-1, 14-2, 14-3, and 14-4.

At least some of the transmitted packet(s) 14T may not be received by the receiver 16 or may be received out of sequence, e.g., due to non-ideal radio conditions or the sending of packets through different lower layer pathways. That is, the packet(s) 14R received by the receiver 16 may not include all of the transmitted packets 14T or may not be received in the same order as the order in which the transmitted packets 14T were transmitted. One or more packets 14-X may therefore be missing at the receiver 16 at any given time. FIG. 1 in this regard shows as an example that the packets 14R received by the receiver 16 as of a certain time include packets with the sequence numbers 14-1, 14-2, and 14-4, i.e., the packet with sequence number 14-3 has not been received yet and is therefore missing.

The receiver 16 according to some embodiments accounts for any missing packet(s) 14-X. The receiver 16 may for instance reorder any of the packet(s) 14R that are received out of sequence, e.g., by re-ordering the packet(s) 14R in sequential order according to their respective sequence numbers, to facilitate in-sequence delivery of the packet(s) 14R to a higher layer of the protocol stack.

For example, as shown, the receiver 16 maintains a reordering window 18 (e.g., a PDCP reordering window) and/or a reordering timer 20 (e.g., a t-reordering timer). The reordering window 18 represents a window of packets considered for reordering, e.g., as reflected by one or more parameters that define the reordering window 18 in terms of a sequence number at the beginning of the window 18 and a sequence number at the end of the window 18. If the receiver 16 has not yet received a certain packet that is within the reordering window 18, the receiver 16 will generally wait for the duration of the reordering timer 20, in anticipation of receiving that missing packet, so that the packets can be delivered in sequence to a higher layer. If the reordering timer 20 expires before receiving the missing packet, though, the receiver 16 may stop waiting and take an action consistent with the understanding that the missing packet will not be received. Such action may for instance involve dropping the missing packet and/or delivering to the higher layer other packets within the reordering window 18 that have been received (without the missing packet).

In the context of the example in FIG. 1, then, the receiver 16 receives packets 14R with sequence numbers 14-1, 14-2, and 14-4, but does not receive the packet with sequence number 14-3, i.e., the packet with sequence number 14-3 is missing. When the packet with sequence number 14-4 is received out-of-sequence while the packet with sequence number 14-3 is still missing, such that the reordering window 18 includes sequence numbers 14-1, 14-2, and 14-4, the receiver 16 starts the reordering timer 20. While the reordering timer 20 is running, the receiver 16 waits to receive the missing packet with sequence number 14-3. If the receiver 16 receives the missing packet before the reordering timer 20 expires, the receiver 16 advances the reordering window 18 and delivers the received packets with sequence numbers 14-1, 14-2, 14-3, and 14-4 in sequence to a higher layer. However, if the receiver 16 does not receive the missing packet by the time the reordering timer 20 expires, the receiver 16 stops waiting for the missing packet and may take an action consistent with the understanding that the missing packet will not be received. For example, expiration of the reordering timer 20 may cause the receiver 16 to resort to out-of-sequence delivery so as to deliver the other packets with sequence numbers 14-1, 14-2, and 14-4 to the higher layer (without the missing packet). Absent other mechanisms, then, waiting for expiry of the reordering timer 20 may delay delivery of received packet(s) 14R to a higher layer of the receiver 16.

Notably, though, the transmitter 12 in these and other embodiments is configured to transmit signaling 22 to the receiver 16. The signaling 22 in some embodiments indicates that the receiver 16 is to not expect one or more packets 14-X. The signaling 22 in other embodiments indicates that the receiver 16 is to consider one or more packets 14-X as discarded, as received, or as delivered to a higher layer of the protocol stack. For example, even if the receiver 16 has not actually received the one or more packets 14-X or delivered the one or more packets 14-X to the higher layer, the signaling 22 may indicate that the receiver 16 is to nonetheless consider (i.e., deem) that the one or more packets 14-X have been received or delivered to the higher layer.

In some embodiments, the signaling 22 prompts the receiver 16 to perform one or more actions, or to stop performing one or more actions, with respect to these one or more packets 14-X. For instance, in embodiments where the receiver 16 is waiting to receive the one or more packets 14-X, the signaling 22 may prompt the receiver 16 to stop waiting on the one or more packets 14-X. In the example of FIG. 1 in this regard, where the receiver 16 waits on the missing packet with sequence number 14-3 while the reordering timer 20 is running, receipt of the signaling 22 while the reordering timer 20 is running may prompt the receiver 16 to stop waiting on the missing packet with sequence number 14-3 even before the reordering timer 20 expires. The signaling 22 may for instance prompt the receiver 16 to no longer expect the missing packet with sequence number 14-3, or to consider the missing packet as discarded, as received, or as delivered to the higher layer, i.e., such that the receiver 16 need not wait for the missing packet any longer. This may involve for instance updating (e.g., advancing) the reordering window 18 and/or otherwise updating one or more parameters at the receiver 16 (e.g., an RX_DELIV parameter indicating a sequence number of the next packet to be delivered to the higher layer) to reflect that the one or more packets 14-X are not expected, that the one or more packets 14-X have been received, that the one or more packets 14-X have been discarded, and/or that the one or more packets 14-X have been delivered to an upper layer. For example, the receiver 16 may remove sequence number(s) of the one or more packets 14-X from a list of expected sequence numbers.

In the context of embodiments herein, then, considering a packet as discarded, as received, or as delivered to an upper layer means regarding (i.e., treating) the packet as having been discarded, received, or delivered to an upper layer. In other words, the receiver 16 herein considers a packet as discarded, as received, or as delivered to an upper layer if the receiver 16 takes the same action(s) for that packet as the receiver 16 would have taken had the packet actually been discarded, received, or delivered to an upper layer.

In these and other embodiments, then, the signaling 22 may shorten the amount of time that the receiver 16 waits on missing packets. Indeed, under some circumstances where the transmitter 12 has knowledge that the receiver 16 will not or is not likely to receive the missing packet(s) 14-X, at least within certain latency requirements, the transmitter 12 may send the signaling 22 to the receiver 16 so that the receiver 16 will not wait on the missing packet(s) 14-X longer than necessary, e.g., so that the receiver 16 can stop waiting on the missing packet(s) 14-X even before expiration of the reordering timer 20.

Some embodiments may thereby reduce the delay attributable to packet reordering and thereby improve compliance with latency requirements. Where the packets are PDCP PDUs, for instance, some embodiments make it possible to deliver PDCP PDUs to the application layer faster, with lower latency, and/or prevent the delay attributable to waiting on missing PDCP PDUs from making successfully received PDCP PDUs too old to be useful to the application layer. One or more embodiments may accordingly increase the reliability of the user plane protocol, e.g., for New Radio (NR).

In some embodiments, the transmitter 12 makes a decision as to whether or not to transmit the signaling 22 to the receiver 16. The transmitter 12 may for instance make this decision based on an estimate or prediction as to whether and/or when the receiver 16 would receive the one or more packets 14-X. For example, in some embodiments, the transmitter 12 estimates a delay until the one or more packets 14-X would be or will be received by the receiver 16, e.g., at a PDCP layer or an application layer of the receiver 16. The transmitter may then make the decision as to whether or not to transmit the signaling 22 based on that estimated delay, e.g., by deciding to transmit the signaling 22 if the estimated delay exceeds a threshold which may reflect the maximum delay allowable for the one or more packets 14-X.

Examine for instance embodiments where the transmitter 12 (e.g., in the form of a PDCP transmitter) serves a latency critical traffic application. In this case, the transmitter 12 may use an estimate or prediction of radio conditions and/or radio resource availability to estimate the delay time (e.g., losses, retransmission, queueing) of the packets (e.g., PDCP PDUs) currently buffered for transmission. The delay time may depend on at which bitrate the air interface can deliver the queued packets, which in turn depends on which radio resources are available and what quality they have. Regardless, if the delay time exceeds a threshold, the transmitter 12 may exclude the queued packets from future transmission or simply discard those packets. The threshold may be heuristic or may be determined based on feedback from the traffic application served. The threshold could alternatively or additionally depend on an expected variation of the delay estimate, e.g., dependent on mobility estimates or the number of active bearers with higher priority in the serving cell of the receiver 16. In any event, the transmitter 12 may then inform the receiver 16 about this decision.

Alternatively or additionally, the transmitter 12 may predict whether or not the receiver 16 will have to perform reordering to receive all packets and/or whether or not such reordering will take longer than allowed by applicable latency requirements. If this is the case, the transmitter 12 may decide to transmit the signaling 22, to exclude one or more packets 14-X that would delay reordering and/or jeopardize the latency requirements.

In some embodiments, the one or more packets 14-X are packets that the transmitter 12 has transmitted to the receiver 16 but the transmitter 12 nonetheless determines the packet(s) 14-X will not reach the receiver 16 or will reach the receiver 16 too late. In other embodiments, the one or more packets 14-X are packets that the transmitter has assigned one or more sequence numbers to, but the transmitter 12 nonetheless discards the packet(s) 14-X before actually transmitting them. In these and other embodiments, the transmitter 12 may keep a “packet delay budget”. This timer could be started when the packet arrives from a higher layer to the transmitter (e.g., at the PDCP layer), or when the transmitter 12 sends the packet (e.g., from PDCP) to lower layers (depending on the purpose of the timer). In any case, it is a timer to quantity if the packet is too old. If the packet becomes “old”, then the transmitter may discard the packet. If the packet was already transmitted to the receiver 16, then the transmitter 12 may also send the signaling 22 herein to the receiver 16. If the packet was not sent when the packet became “old”, this may create a sequence number (SN) gap. If the transmitter 12 fixes the gap by fixing the SN of other packets that were already assigned SNs, there is no need to inform the receiver 16 via signaling 22. On the other hand, if the transmitter 12 does not fix the SN gap, the transmitter 12 may send the signaling 22.

Regardless, in some embodiments, the one or more packets 14-X that the receiver 16 is to not expect, or is to consider as discarded, as received, or as delivered to a higher layer, are indicated by the signaling 22, either explicitly or implicitly. That is, the receiver 16 is notified explicitly or implicitly about the sequence number(s) of the one or more packets 14-X.

For example, the signaling 22 may explicitly indicate the one or more respective sequence numbers (SNs) of the one or more packets 14-X that the receiver 16 is to not expect, or is to consider as discarded, as received, or as delivered to a higher layer. In the example of FIG. 1, then, the signaling 22 would explicitly indicate sequence number 14-3.

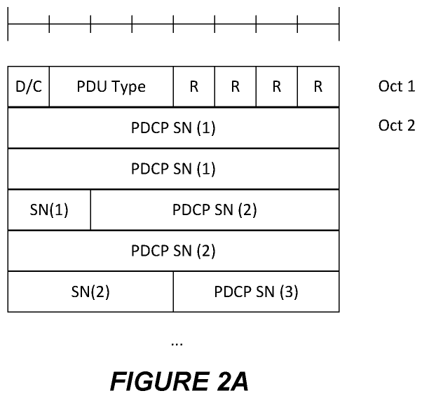

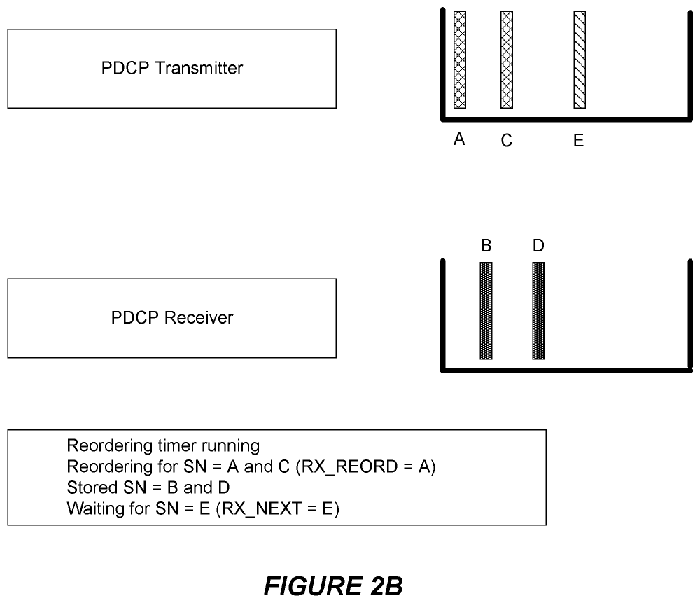

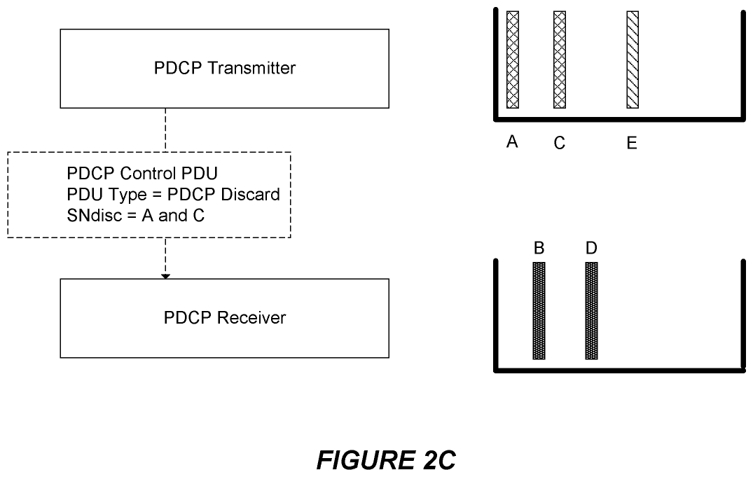

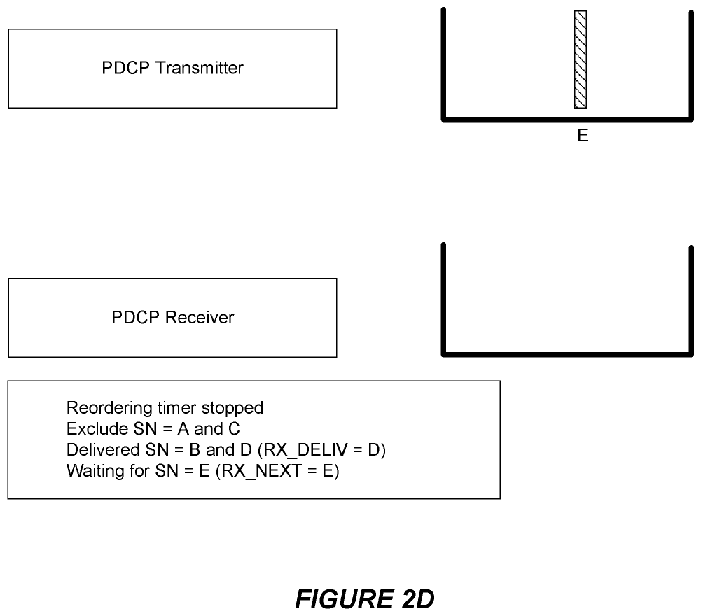

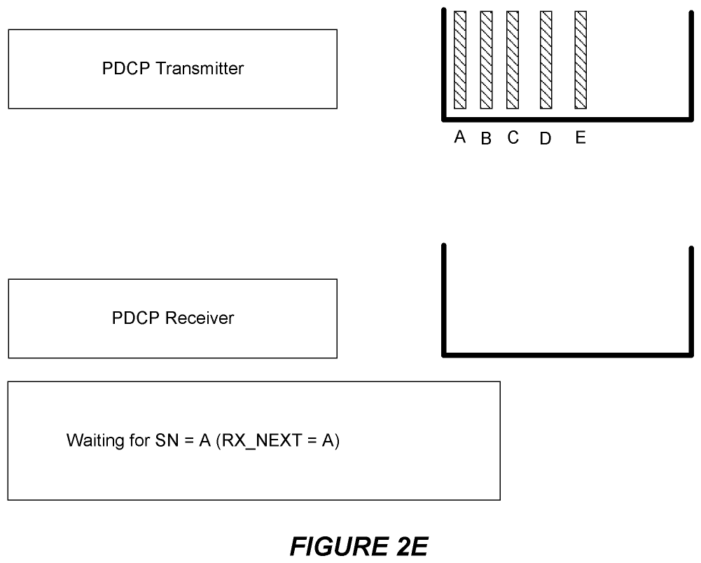

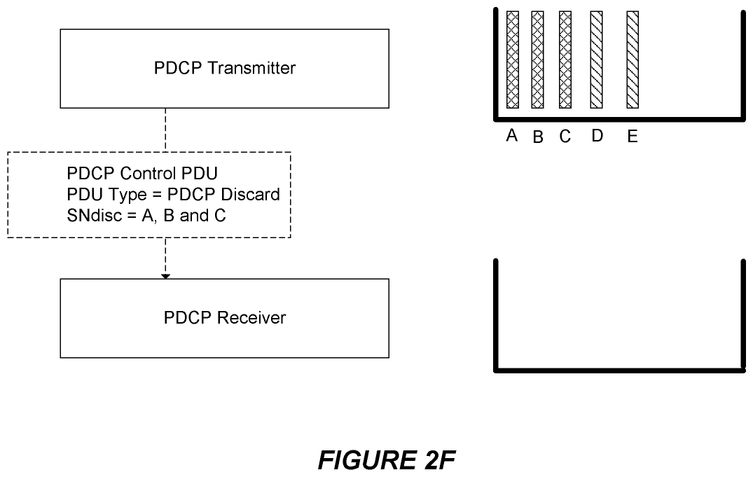

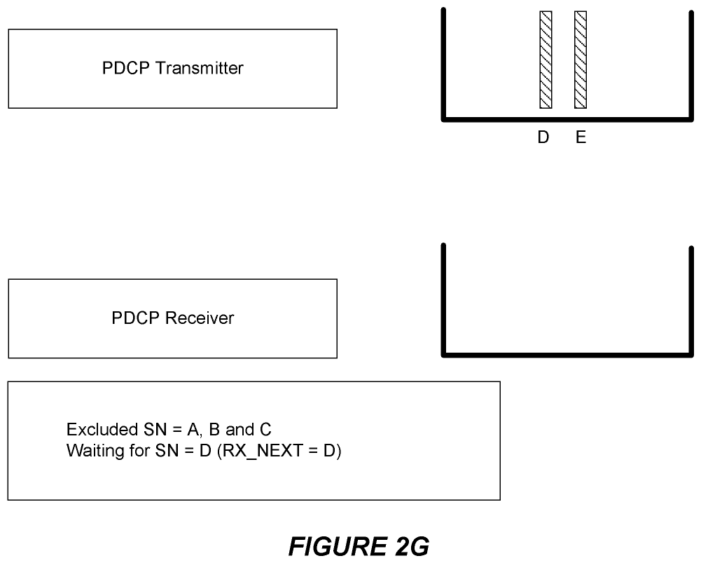

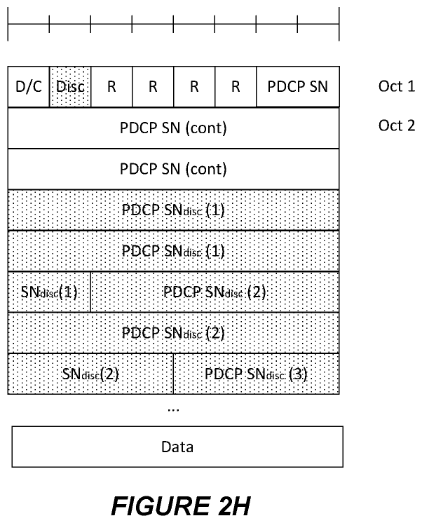

Examine an example where the one or more packets 14-X are one or more PDCP packets and the signaling 22 is or is included in a PDCP Control PDU. The PDCP Control PDU may be of a type (e.g., PDCP Discard) dedicated to indicating that the receiver 16 is to not expect, or is to consider as discarded, as received, or as delivered to a higher layer, one or more packets 14-X. FIG. 2A shows an example of the signaling 22 in the form of a PDCP Control PDU that explicitly indicates one or more PDCP SNs of the one or more packets 14-X, e.g., where the SN length is 18 bits. In this example, the PDCP Control PDU explicitly contains all affected PDCP SNs, e.g., that are to be discarded at the receiver 16. In some embodiments, the receiver 16 considers as if the indicated PDCP SNs had been received/delivered to higher layers, which allows the receiver 16 to update the reordering window 18 variables accordingly. For example, the variable RX_DELIV may be updated to the COUNT value of the first PDCP SDU which has not been delivered to upper layers and is not listed in the PDCP Control PDU, with COUNT value>RX_DELIV. In some embodiments, the reordering timer 20 is stopped if it was running and there are no more SN gaps in the reordering window 18. Otherwise, if there are gaps, the reordering 20 timer is restarted.

An example of a solution with a PDCP Control PDU with multiple SNs indicated and the reordering timer 20 running in the PDCP receiver is visualized in FIGS. 2B, 2C, and 2D.

FIG. 2B shows the starting state of the example with 2 PDUs received in the PDCP receiver, namely PDUs B and D. The PDCP receiver's reordering timer is running while the PDCP receiver waits to receive PDUs with SNs of A, C, and E. The PDCP receiver correspondingly has a parameter RX_REORD set to SN=A, has stored SNs B and D, and has a parameter RX_NEXT set to SN=E.

The PDCP transmitter decides to exclude PDUs A and C. To do so, the transmitter as shown in FIG. 2C explicitly notifies the receiver of the multiple SNs to be excluded with a PDCP Control PDU with PDU type PDCP Discard. The PDCP Control PDU therefore includes a PDU Type=PDCP Discard and a SNdisc parameter set to the SNs of A and C.

FIG. 2D shows the result after explicit discard indication through a PDCP Control PDU with PDU Type PDCP Discard and multiple SNdiscard indicated. Responsive to receiving the PDCP Control PDU, the PDCP receiver stops the reordering timer and excludes PDUs with SNs A and C. Correspondingly, the PDCP receiver delivers SNs B and D to a higher layer (RX_DELIV=D) and waits for the next PDU with SN=E (RX_NEXT=E).

An example of a solution with a PDCP Control PDU with multiple SNs indicated and no reordering timer running in the PDCP receiver is visualized in FIGS. 2E, 2F, and 2G.

FIG. 2E shows the starting state of the example with no PDUs received in the PDCP receiver. The PDCP receiver's reordering timer is not running. The PDCP receiver correspondingly is waiting for a PDU with a SN of A, i.e., has a parameter RX_NEXT set to SN=A.

The PDCP transmitter wants to discard PDUs with SNs A, B, and C. To do so, the transmitter as shown in FIG. 2F explicitly notifies the receiver of the multiple SNs to be discarded with a PDCP Control PDU with PDU type PDCP Discard. The PDCP Control PDU therefore includes a PDU Type=PDCP Discard and a SNdisc parameter set to the SNs of A, B, and C.

FIG. 2G shows the result after explicit discard indication through a PDCP Control PDU with PDU Type PDCP Discard and multiple SNdiscard indicated. Responsive to receiving the PDCP Control PDU, the PDCP receiver excludes PDUs with SNs A, B, and C. Correspondingly, the PDCP receiver starts waiting for the next PDU with SN=D (RX_NEXT=D).

In still other embodiments, the one or more packets 14-X are one or more PDCP packets and the signaling 22 is or is included in a PDCP Data PDU. In this case, the transmitter 12 may wait for the next PDCP Data PDU and include the signaling 22 in that PDCP Data PDU. FIG. 2H shows an example of the signaling 22 in the form of a PDCP Data PDU that explicitly indicates (via one or more PDCP SNdisc fields) one or more PDCP SNs of the one or more packets 14-X, e.g., where the SN length is 18 bits. In this example, the PDCP Data PDU explicitly contains all affected PDCP SNs, e.g., that are to be discarded at the receiver 16. The Disc field in this example indicates whether the receiver 16 is to not expect, or is to consider as discarded, as received, or as delivered to a higher layer, one or more packets 14-X. The Disc field may thereby indicate whether the PDCP Data PDU includes the one or more PDCP SNdisc fields.

Whether the number of PDCP SNs to report is variable, the signaling 22 in some embodiments indicates the number of PDCP SNs which are included in the report, or the length of these fields. Alternatively, the COUNT value can be used.

In some embodiments, the receiver 16 in this case also considers as if the indicated PDCP SNs had been received/delivered to higher layers, which allows the receiver 16 to update the reordering window 18 variables accordingly. For example, the variable RX_DELIV may be updated to the COUNT value of the first PDCP SDU which has not been delivered to upper layers and is not listed in the PDCP Control PDU, with COUNT value>RX_DELIV. In some embodiments, the reordering timer 20 is stopped if it was running and there are no more SN gaps in the reordering window 18. Otherwise, if there are gaps, the reordering 20 timer is restarted.

Although illustrated in these examples with PDCP SNs, the COUNT value of the given PDCP PDU(s) could be reported instead.

In other embodiments, the signaling 22 explicitly indicates only one sequence number even if there is more than one missing packet 14-X. In this case, the receiver 16 may deduce or otherwise determine from the signaling 22 the sequence number(s) of the one or more packets 14-X that the receiver 16 is to not expect, or is to consider as discarded, as received, or as delivered to a higher layer.

For example, the signaling 22 may explicitly indicate the sequence number of a packet having the highest sequence number among the one or more respective sequence numbers of the one or more packets 14-X that are to be considered as discarded, not expected, considered as delivered to an upper layer, or considered as received. The receiver 16 in this case may consider as discarded, not expect, consider as delivered to an upper layer, or consider as received each packet with a sequence number up to the indicated sequence number. This may include each packet that has a sequence number less than or equal to the indicated sequence number and that the receiver 16 is waiting on as of receipt of the signaling 22, e.g., each packet that has a sequence number less than or equal to the indicated sequence number and that, as of receipt of the signaling 22, is within the reordering window 18 of the receiver 16.

In one or more such embodiments where the one or more packets 14-X are one or more PDCP packets, the receiver 16 considers as if all PDCP SNs up to the indicated PDCP SN had been received/delivered to higher layers, which allows the receiver 16 to update the reordering window 18 variables accordingly. For example, the variable RX_DELIV may be updated to the COUNT value of the first PDCP SDU which has not been delivered to upper layers with COUNT value>the indicated PDCP SN and with COUNT value>RX_DELIV. In some embodiments, the reordering timer 20 is stopped if it was running and there are no more SN gaps in the reordering window 18. Otherwise, if there are gaps, the reordering 20 timer is restarted.

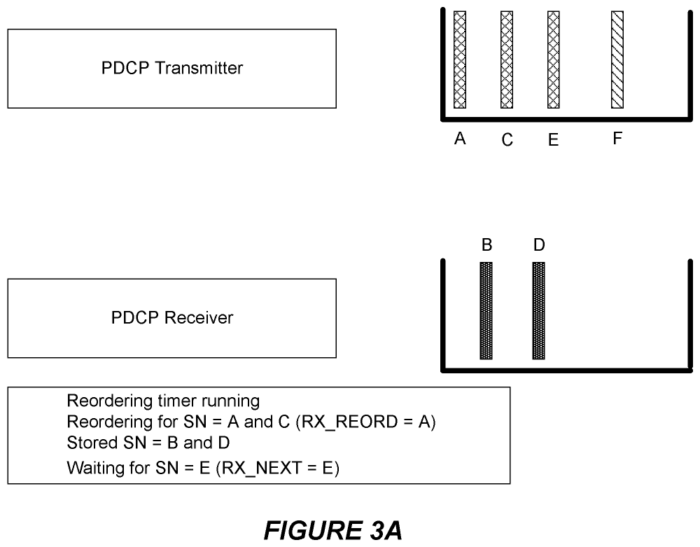

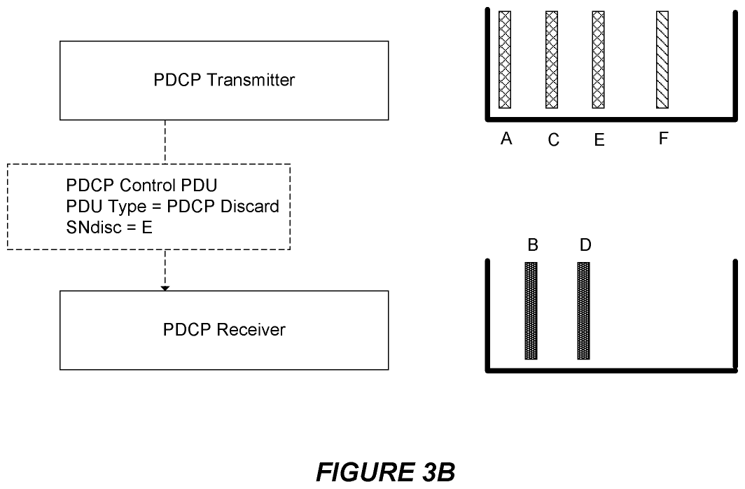

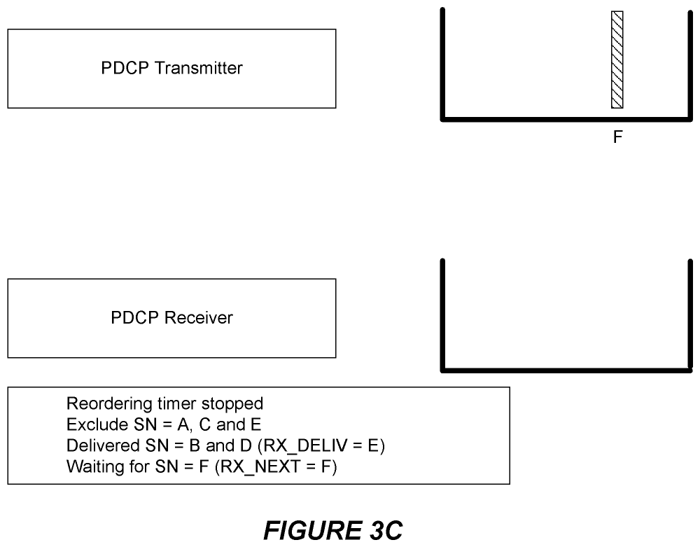

An example of a solution with a PDCP Control PDU with one SN indicated and the reordering timer running in the PDCP receiver is visualized in FIGS. 3A, 3B, and 3C.

FIG. 3A shows the starting state of the example with 2 PDUs received in the PDCP receiver, namely PDUs B and D. The PDCP receiver's reordering timer is running while the PDCP receiver waits to receive PDUs with SNs of A, C, and E. The PDCP receiver correspondingly has a parameter RX_REORD set to SN=A, has stored SNs B and D, and has a parameter RX_NEXT set to SN=E.

The PDCP transmitter decides to exclude PDUs A, C, and E. To do so, the transmitter as shown in FIG. 3B explicitly notifies the receiver of SN=E as the highest SN among the multiple SNs A, C, and E to be excluded. That is, the transmitter uses a PDCP Control PDU with PDU Type=PDCP Discard and a SNdisc parameter set to the SN of E.

FIG. 3C shows the result after implicit discard indication through a PDCP Control PDU with PDU Type PDCP Discard and single SNdiscard indicated. Responsive to receiving the PDCP Control PDU, the PDCP receiver stops the reordering timer and excludes PDUs with SNs A, C, and E. Correspondingly, the PDCP receiver delivers SNs B and D to a higher layer (RX_DELIV=E) and waits for the next PDU with SN=F (RX_NEXT=F).

In another example, the signaling 22 may be included in a data packet (e.g., a PDCP Data PDU) with a sequence number. The signaling 22 in this case may take the form of a field (e.g., a Discard bit field) which indicates the receiver 16 is to discard, not expect, consider as delivered to an upper layer, or consider as received one or more packets 14-X, without explicitly indicating the sequence number of any of those packet(s) 14-X. The receiver 16 in this case may consider as discarded, not expect, consider as delivered to an upper layer, or consider as received each packet with a sequence number up to the sequence number of the data packet.

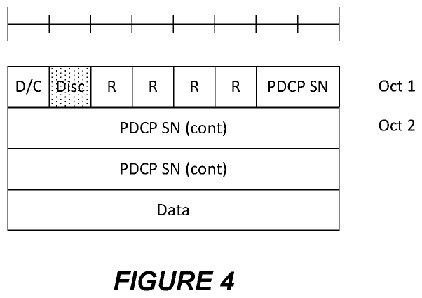

FIG. 4 shows one example of the signaling 22 in the form of a Discard bit field in a PDCP Data PDU. This example is similar to the one shown in FIG. 2H, except that the sequence number(s) of the one or more packets 14-X is derivable from the PDCP Data PDU's sequence number, rather than being explicitly indicated in the PDCP Data PDU itself.

In one or more of these embodiments where the PDCP Data PDU contains only an implicit indication (“Disc” bit), the receiver 16 considers as if all PDCP SNs up to the indicated PDCP SN minus one (corresponding to the PDCP SN of the current PDCP SN) had been received/delivered to higher layers. The variable RX_DELIV is updated to the COUNT value of the first PDCP SDU which has not been delivered to upper layers with COUNT value>RX_DELIV. Accordingly, in this case, the PDCP Data PDU carries the SN of the said PDCP Data PDU, plus an indication to discard. The SN is given implicitly, meaning that the SN which is carried already in the PDCP header is used as an input to decide what is discarded. The receiver will discard all up to the (SN-1).

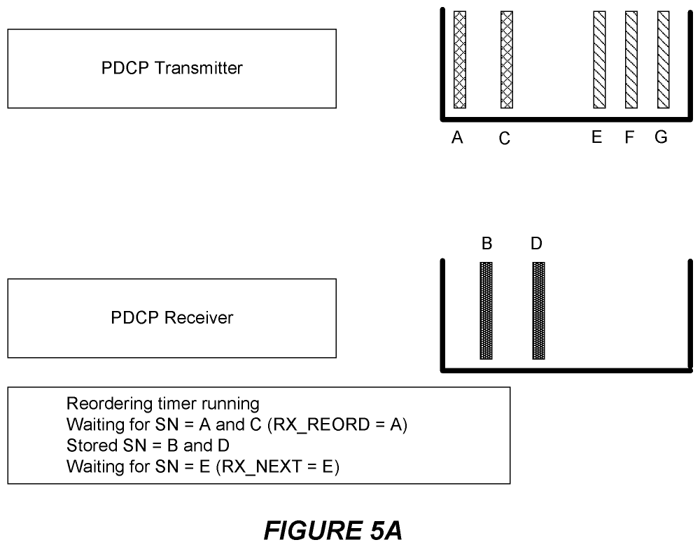

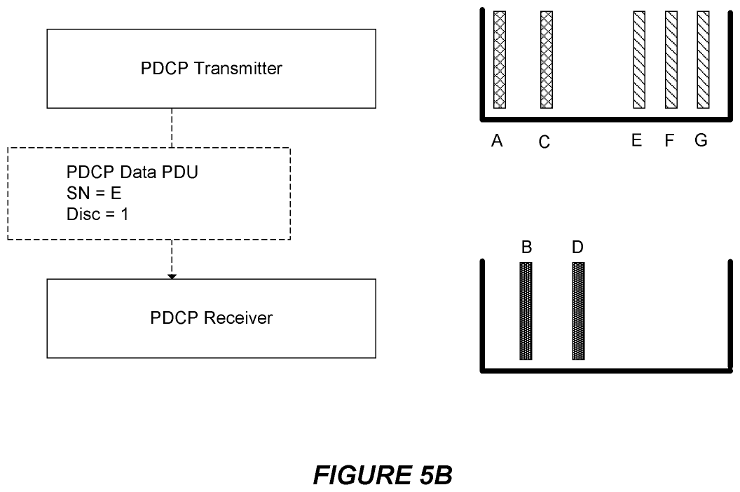

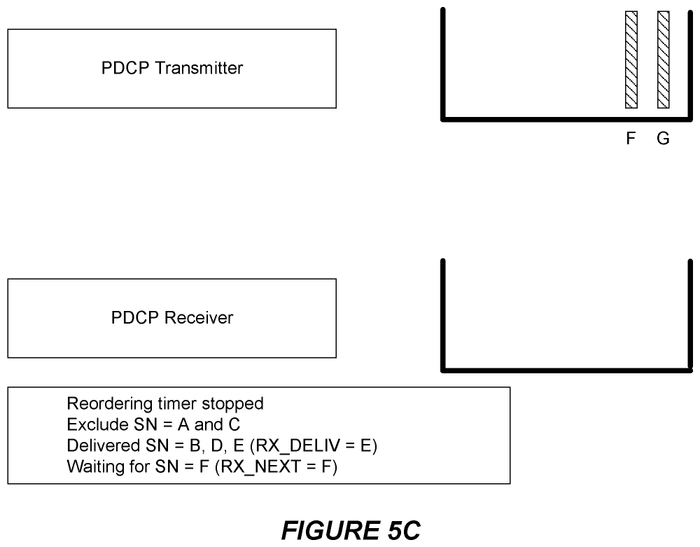

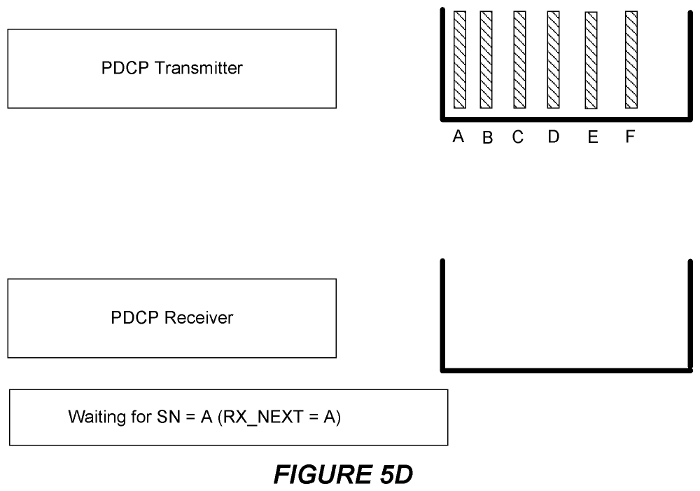

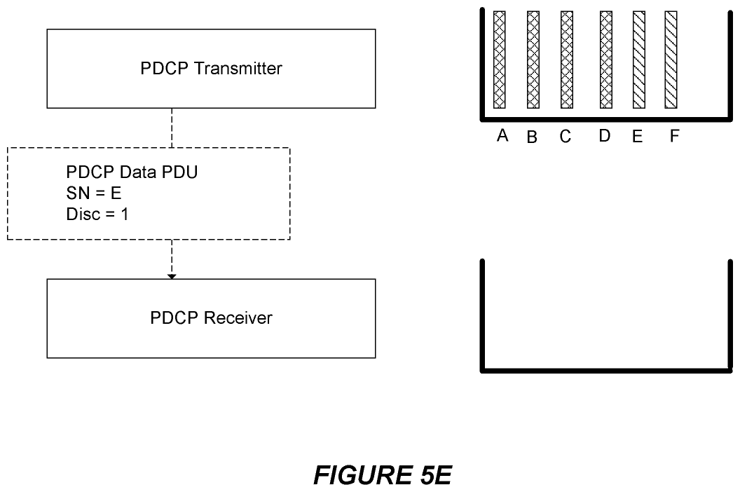

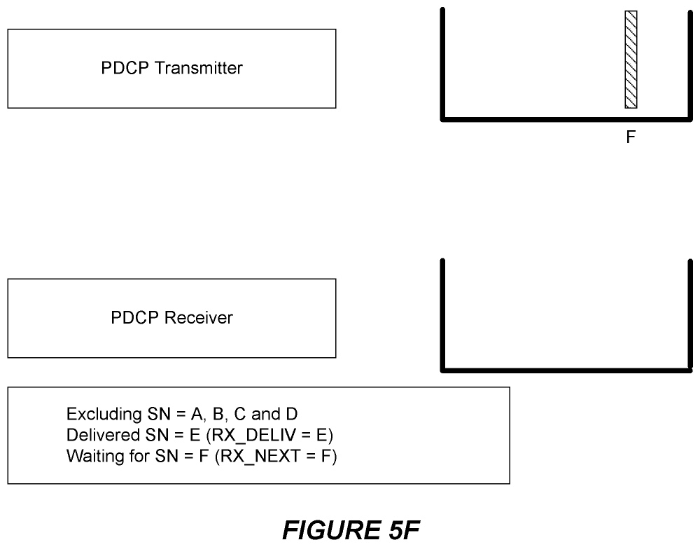

An example of a solution with a PDCP Data PDU with a discard bit and the reordering timer running in the PDCP receiver is visualized in FIGS. 5A, 5B, and 5C.

FIG. 5A shows the starting state of the example with 2 PDUs received in the PDCP receiver, namely PDUs B and D. The PDCP receiver's reordering timer is running while the PDCP receiver waits to receive PDUs with SNs of A, C, and E. The PDCP receiver correspondingly has a parameter RX_REORD set to SN=A, has stored SNs B and D, and has a parameter RX_NEXT set to SN=E.

The PDCP transmitter decides to exclude PDUs A and C. To do so, the transmitter as shown in FIG. 5B implicitly notifies the receiver to exclude PDUs with SNs of A and C. In particular, the transmitter uses a PDCP Data PDU for SN=E, where the PDU has a discard bit set, i.e., Disc=1. This discard bit indicates the receiver is to consider as if all PDCP SNs up to the indicated PDCP SN=E minus 1, i.e., up to SN=D, had been received/delivered to higher layers.

FIG. 5C shows the result after implicit discard indication through a PDCP Data PDU with discard bit. Responsive to receiving the PDCP Data PDU, the PDCP receiver stops the reordering timer and excludes PDUs with SNs A and C. Correspondingly, the PDCP receiver delivers SNs B, D, and E to a higher layer (RX_DELIV=E) and waits for the next PDU with SN=F (RX_NEXT=F).

An example of a solution with a PDCP Data PDU with a discard bit indicated and no reordering timer running in the PDCP receiver is visualized in FIGS. 5D, 5E, and 5F.

FIG. 5D shows the starting state of the example with no PDUs received in the PDCP receiver. The PDCP receiver's reordering timer is not running. The PDCP receiver correspondingly has a parameter RX_NEXT set to SN=A since the receiver is waiting for the PDU with SN=A.

The PDCP transmitter decides to exclude PDUs A, B, C, and D. To do so, the transmitter as shown in FIG. 5E implicitly notifies the receiver to exclude PDUs with SNs of A, B, C, and D. In particular, the transmitter uses a PDCP Data PDU for SN=E, where the PDU has a discard bit set, i.e., Disc=1. This discard bit indicates the receiver is to consider as if all PDCP SNs up to the indicated PDCP SN=E minus 1, i.e., up to SN=D, had been received/delivered to higher layers.

FIG. 5F shows the result after implicit discard indication through a PDCP Data PDU with discard bit. Responsive to receiving the PDCP Data PDU, the PDCP receiver excludes PDUs with SNs A, B, C, and D. Correspondingly, the PDCP receiver delivers SN E to a higher layer (RX_DELIV=E) and waits for the next PDU with SN=F (RX_NEXT=F).

In yet other embodiments, the signaling 22 does not explicitly indicate any sequence number of any of the one or more packets, but simply indicates the fact that one or more unspecified packets are to be not expected, or considered as discarded, as received, or as delivered to a higher layer. In this case, the receiver 16 may nonetheless deduce or otherwise determine which one or more packets are to be not expected, or considered as discarded, as received, or as delivered to a higher layer. For example, the receiver 16 in some embodiments is to consider as discarded, not expect, consider as delivered to an upper layer, or consider as received each packet that the receiver 16 is waiting on as of receipt of the signaling 22, e.g., each packet that, as of receipt of the signaling 22, is within the reordering window 18 of the receiver 16.

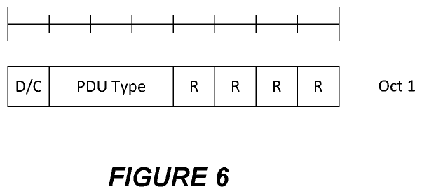

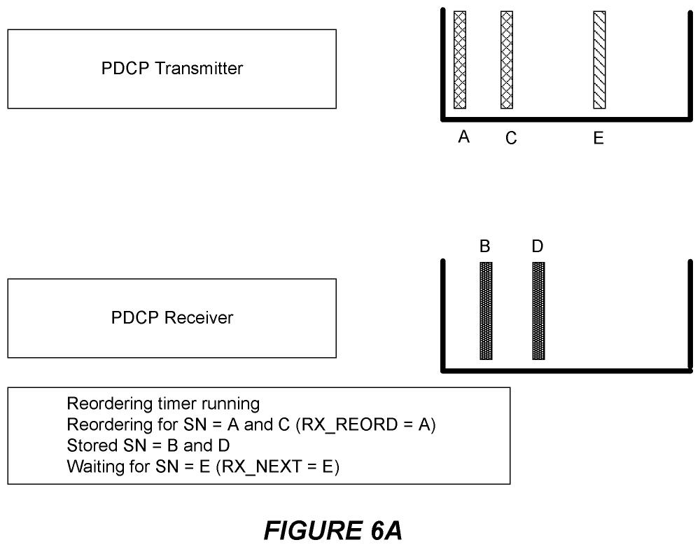

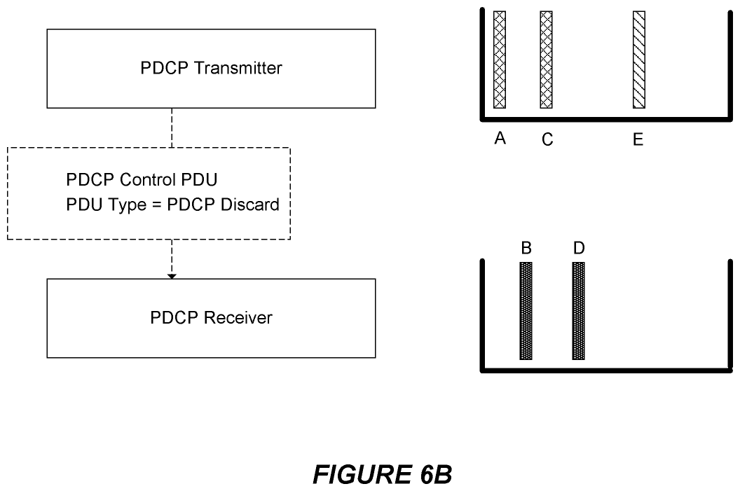

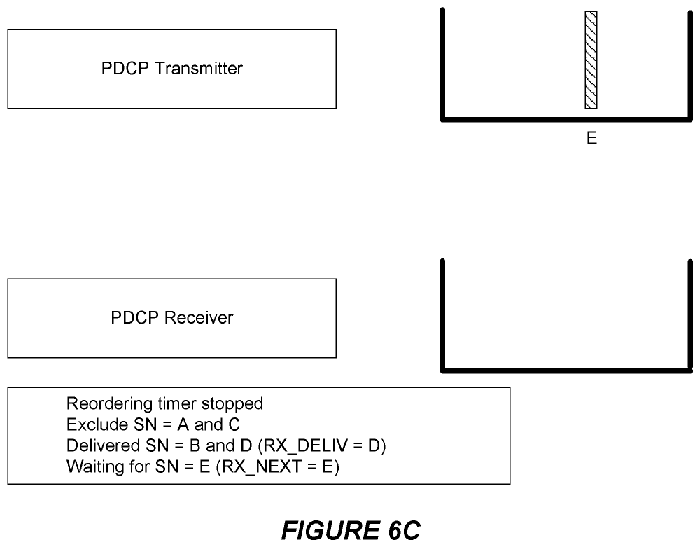

FIG. 6 shows an example the signaling 22 in the form of a PDCP Control PDU (e.g., of type PDCP Discard) that does not explicitly indicate any of the PDCP SNs of the one or more packets 14-X. In such embodiments where the PDCP Control PDU with PDU type of PDCP Discard contains no information about specific PDCP SNdisc, the receiver 16 considers as if all the PDCP SNs inside the reordering window 18 had been received/delivered to higher layers. The variable RX_DELIV is updated to the COUNT value of the first PDCP SDU which has not been delivered to upper layers and with COUNT value>RX_DELIV. In some embodiments, the reordering timer 20 is stopped if it was running and there are no more SN gaps in the receiving window. Otherwise, if there are gaps, the reordering timer 20 is restarted.

An example of a solution with a PDCP Control PDU without any SN indicated and the reordering timer 20 running in the PDCP receiver is visualized in FIGS. 6A, 6B, and 6C.

FIG. 6A shows the starting state of the example with 2 PDUs received in the PDCP receiver, namely PDUs B and D. The PDCP receiver's reordering timer is running while the PDCP receiver waits to receive PDUs with SNs of A, C, and E. The PDCP receiver correspondingly has a parameter RX_REORD set to SN=A, has stored SNs B and D, and has a parameter RX_NEXT set to SN=E.

The PDCP transmitter decides to exclude PDUs A and C. To do so, the transmitter as shown in FIG. 6B implicitly notifies the receiver to exclude PDUs with SNs of A and C. In particular, the transmitter uses a PDCP Control PDU of type PDCP Discard.

FIG. 6C shows the result after implicit discard indication through a PDCP Control PDU with type PDCP Discard. Responsive to receiving the PDCP Control PDU, the PDCP receiver stops the reordering timer and excludes PDUs with SNs A and C. Correspondingly, the PDCP receiver delivers SNs B and D to a higher layer (RX_DELIV=D) and waits for the next PDU with SN=E (RX_NEXT=E).

Note that embodiments herein may be applicable in any type of communication network and/or for delivery of any type of packets. Some embodiments are nonetheless particularly applicable to for conveying traffic for an application with bounded latency. In some embodiments in this regard, the packet(s) 14T, 14R in FIG. 1 may convey traffic for an application with bounded latency, such as an eXtended Reality (XR) application.

In some embodiments, the transmitter 12 and receiver 16 are configured for use in a wireless communication network, e.g., a 5G network. In one such embodiment, the transmitter 12 is or is included in a wireless device (e.g., a user equipment, UE) and the receiver 16 is or is included in a radio network node (e.g., a base station or a distributed radio unit). In another embodiment, the receiver 16 is or is included in a wireless device (e.g., a user equipment, UE) and the transmitter 12 is or is included in a radio network node.

Some embodiments for example are applicable in a 5G network. 5G NR is designed to support applications demanding high rate and low latency, in line with the requirements posed by the support of XR and cloud gaming applications in NR networks.

In particular, some embodiments herein are applicable for low-latency applications like XR and cloud gaming, which require bounded latency, not necessarily ultra-low latency. The end-to-end latency budget may be in the range of 20-80 ms, which needs to be distributed over several components including application processing latency, transport latency, radio link latency, etc. For these applications, short transmission time intervals (TTIs) or mini-slots targeting ultra-low latency may not be effective.

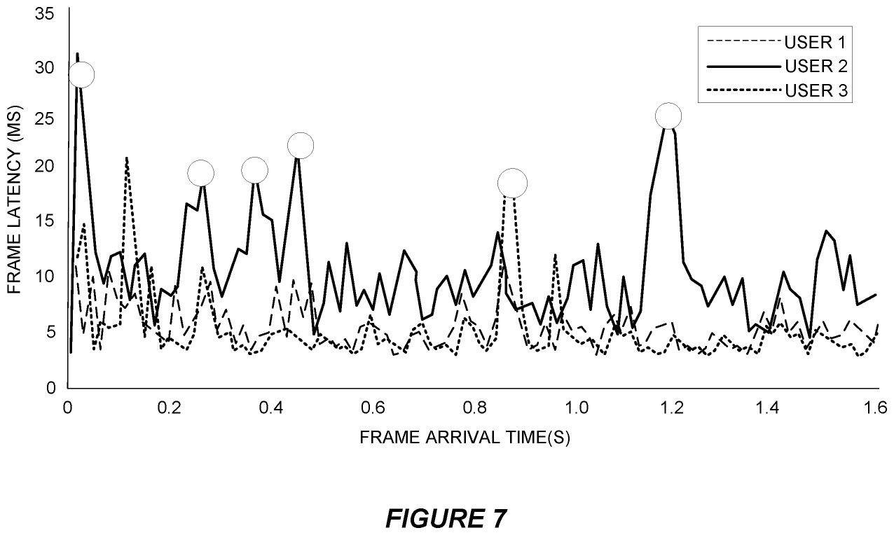

FIG. 7 shows an example of frame latency measured over a radio access network (RAN), excluding application & core network latencies. It can be seen that frame latency spikes exist in the RAN. The sources for the latency spikes may include queuing delay, time-varying radio environments, time-varying frame sizes, instantaneous shortage of radio resources or inefficient radio resource allocation, among others. Tools that can help to remove latency spikes are beneficial to enable better 5G support for this type of traffic.

In addition to bounded latency requirements, applications like XR and cloud gaming also require high rate transmission. This can be seen from the large frame sizes originated from this type of traffic. The typical frame sizes may range from tens of kilobytes to hundreds of kilobytes. The frame arrival rates may be 60 or 120 frames per second (fps). As a concrete example, a frame size of 100 kilobytes and a frame arrival rate of 120 fps can lead to a rate requirement of 95.8 Mbps.

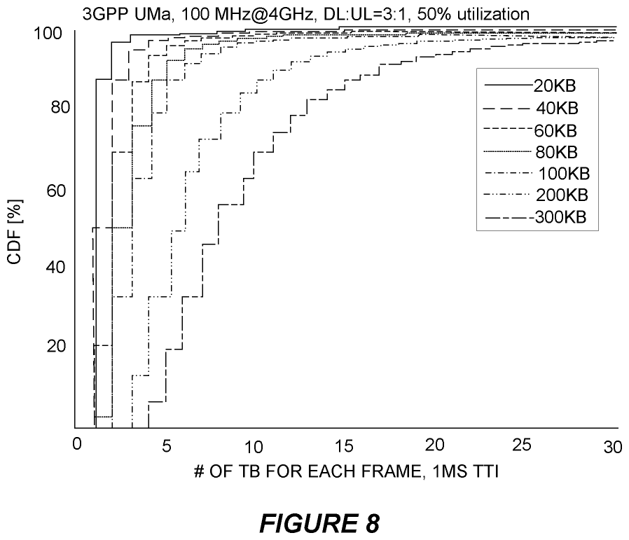

A large video frame is usually fragmented into smaller IP packets and transmitted as several transport blocks (TBs) over several TTIs in RAN. FIG. 8 shows an example of the cumulative distribution functions of the number of transport blocks required to deliver a video frame with size ranging from 20 KB to 300 KB. For example, FIG. 8 shows that for delivering the frames with a size of 100 KB each, the median number of needed TBs is 5.

Some embodiments herein apply to packets at a PDCP layer. In network transmission operation, data travels from a PDCP transmitter to a PDCP receiver as PDCP Protocol Data Units (PDUs). The PDUs have a maximum size. The original data from the application is divided into partitions possible to fit into these PDUs, thus there can be many PDUs for one application data transmission. These PDUs are then ordered with sequence numbers (SN) by the PDCP transmitter and transmitted in this order. However, because of outside factors, such as non-ideal radio conditions leading to retransmissions or sending packets through different lower layer pathways, packets may reach the receiver out of order, or some packets are dropped so that the receiver will not get those within the latency requirement.

The receiver keeps control of the SN so it can discard, duplicate, and perform reordering and in-order delivery. The receiving PDCP handles reordering by checking the SN of the received PDUs. If receiving a PDU with a higher SN value than expected (which is based on what has been previously received), the reordering timer (t-reordering) is started with the lower edge set according to the old expected SN. When the reordering timer is running, all SNs received inside the reordering timer will be stored and the window edge updated constantly. Normally, when all packets have been received, the reordering timer expires and the PDCP receiver will deliver all stored PDUs to the higher layers (in ascending order). There is also a possibility to configure the PDCP to allow delivery of PDCP PDUs to the application, even if there are missing packets.

Some embodiments herein address one or more problems in this context. In particular, there may be cases that the PDCP transmitter side has discarded PDCP SDUs or PDCP PDUs for diverse reasons, e.g., they become too old. In these situations, there are no reasons for the PDCP receiver to keep waiting for those PDCP PDUs. Since the PDCP receiver entity does not know that the PDCP transmitter discarded packets, there is a high risk that the later received packets corresponding to the next application PDU take an unnecessarily long time in the PDCP buffer and are wasted because the old PDCP PDUs are kept in the buffer for so long before being delivered to the higher layer.

Heretofore, with traditional PDCP implementation, if the PDCP receiver experiences gaps in the received PDU SN, this will trigger the reordering timer and storing of PDUs until the reordering timer expires. This will create extra time until the received PDCP PDUs are delivered to the application layer. This in turn may make the already received PDUs useless for the application layer (as may be the case with XR traffic). Even in the case of the late PDCP PDUs received with just a small delay, the time sensitivity of the traffic may render them useless and waiting for them pointless.

In some cases, the application layer may be able to handle packets which are not received in sequence. Yet, even in the cases in which the receiver PDCP entity is configured to deliver to higher layers PDCP PDUs even if it is still waiting for missing packets, the PDCP is running the t-reordering timer. T-reordering could halt the receiving window in the worst case. Halting the receiving window, when done incorrectly, results in packet losses of more important data, e.g., the packets for the later application PDU.

Certain aspects of the present disclosure and their embodiments may provide solutions to these or other challenges. According to some embodiments, the PDCP transmitter predicts that the PDCP receiver will have to perform reordering to receive all PDU SNs and this will take more time than the latency requirement. The PDCP transmitter thus decides to exclude some PDU SNs. In particular, the PDCP transmitter messages the PDCP receiver with a PDCP control PDU (alternatively in the next PDCP data PDU) that some PDU SNs should not be expected. The PDCP receiver, when receiving the message from PDCP transmitter, stops reordering and removes the specified SNs from the list of expected PDUs.

Certain embodiments may provide one or more of the following technical advantage(s). Some embodiments make it possible to, in some cases, deliver PDCP PDUs to the application layer faster, thus with lower latency, and avoid successful PDCP receptions becoming too old to be useful before delivering to them to the application layer while waiting for unsuccessful transmissions or dropped packets, thus in some sense increasing the reliability of the NR user plane protocol.

As used herein, a PDCP PDU is a bit string that is byte aligned (i.e. multiple of 8 bits) in length. Bit strings are represented by tables in which the most significant bit is the leftmost bit of the first line of the table, the least significant bit is the rightmost bit on the last line of the table, and more generally the bit string is to be read from left to right and then in the reading order of the lines. The bit order of each parameter field within a PDCP PDU is represented with the first and most significant bit in the leftmost bit and the last and least significant bit in the rightmost bit.

PDCP SDUs are bit strings that are byte aligned (i.e. multiple of 8 bits) in length. A compressed or uncompressed SDU is included into a PDCP PDU from the first bit onward.

The PDCP data PDU is used to convey: i) a PDCP SDU SN, ii) user plane data containing an uncompressed PDCP SDU, iii) user plane data containing a compressed PDCP SDU, iv) control plane data, or v) a message authentication code for integrity (MAC-I) field for signaling radio bearers (SRBs).

The PDCP control PDU is used to convey: i) a PDCP status report indicating which PDCP SDUs are missing and which are not following a PDCP re-establishment, and ii) header compression control information, e.g. interspersed robust header compression (ROHC) feedback.

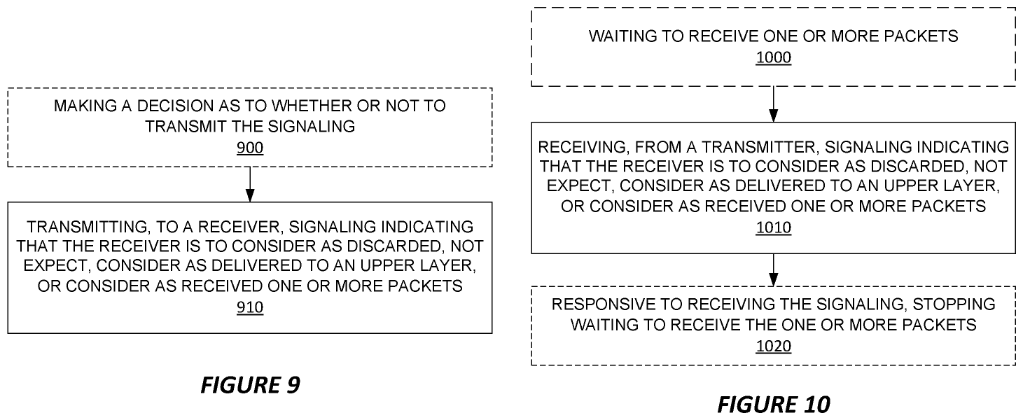

In view of the above modifications and variations, FIG. 9 depicts a method performed by a transmitter 12 configured for use in a wireless communication network in accordance with particular embodiments. The method includes transmitting, to a receiver 16, signaling 22 indicating that the receiver 16 is to consider as discarded, not expect, consider as delivered to an upper layer, or consider as received one or more packets 14-X (Block 910). That is, the signaling 22 indicates that the receiver 16 is to consider the one or more packets 14-X as discarded, to not expect the one or more packets 14-X, to consider the one or more packets 14-X as delivered to an upper layer, or to consider the one or more packets 14-X as received.

In some embodiments, the method also comprises making a decision as to whether or not to transmit the signaling 22 (Block 900). For example, the decision may be made based on an estimated delay until a packet would be or will be received by the receiver 16.

In some embodiments, the signaling 22 is included in a data packet with a sequence number, and the receiver 16 is to consider as discarded, not expect, consider as delivered to an upper layer, or consider as received each packet that has a sequence number less than the sequence number of the data packet.

In some embodiments, the signaling 22 does not explicitly indicate which one or more packets 14-X are to be considered as discarded, not expected, considered as delivered to an upper layer, or considered as received. In one such embodiment, the receiver 16 is to consider as discarded, not expect, consider as delivered to an upper layer, or consider as received each packet that, as of receipt of the signaling 22, is within a reordering window of the receiver 16.

In some embodiments, the transmitter 12 is a Packet Data Convergence Protocol, PDCP, transmitter, the receiver 16 is a PDCP receiver, and the one or more packets 14-X are one or more PDCP packets.

In some embodiments, the signaling 22 is or is included in a PDCP packet.

In some embodiments, the signaling 22 is or is included in a PDCP control protocol data unit, PDU, and the PDCP control PDU is a type of PDCP control PDU dedicated or specific for indicating that the receiver 16 is to consider as discarded, not expect, consider as delivered to an upper layer, or consider as received one or more packets 14-X.

In some embodiments, the signaling 22 is or is included in a PDCP data PDU. In one embodiment, the PDCP data PDU includes a field that indicates the receiver 16 is to consider as discarded, not expect, consider as delivered to an upper layer, or consider as received one or more packets 14-X. In another embodiment, the PDCP data PDU includes a field that indicates whether one or more sequence numbers indicated by the PDCP data PDU are one or more respective sequence numbers of one or more packets 14-X that the receiver 16 is to consider as discarded, not expect, consider as delivered to an upper layer, or consider as received.

In some embodiments, the method further comprises deciding that the receiver 16 is to consider as discarded, not expect, consider as delivered to an upper layer, or consider as received one or more packets 14-X, and wherein said transmitting is performed based on said deciding.

In some embodiments, the method further comprises making a decision as to whether or not to transmit the signaling 22. In one such embodiment, the method further comprises estimating a delay until a packet would be or will be received by the receiver 16, the decision is made based on the estimated delay, the delay is a delay until the packet would be or will be received at a PDCP layer or an application layer at the receiver 16, and making the decision comprises making the decision to transmit the signaling 22 if the estimated delay exceeds a threshold.

FIG. 10 depicts a method performed by a receiver 16 configured for use in a wireless communication network in accordance with other particular embodiments. The method includes receiving, from a transmitter 12, signaling 22 indicating that the receiver 16 is to consider as discarded, not expect, consider as delivered to an upper layer, or consider as received one or more packets 14-X (Block 1010). That is, the signaling 22 indicates that the receiver 16 is to consider the one or more packets 14-X as discarded, to not expect the one or more packets 14-X, to consider the one or more packets 14-X as delivered to an upper layer, or to consider the one or more packets 14-X as received.

In some embodiments, the method also comprises waiting to receive the one or more packets 14-X (Block 1000). In this case, the method may also comprise, responsive to receiving the signaling 22, stopping waiting to receive the one or more packets 14-X (Block 1020).

Alternatively or additionally, the method may comprise, based on the signaling 22, updating a reordering window 18 at the receiver 16.

In some embodiments, the signaling 22 indicates which one or more packets 14-X are to be considered as discarded, not expected, considered as delivered to an upper layer, or considered as received by explicitly indicating each of one or more respective sequence numbers of the one or more packets 14-X. In other embodiments, the signaling 22 indicates which one or more packets 14-X are to be considered as discarded, not expected, considered as delivered to an upper layer, or considered as received by explicitly indicating a sequence number of a packet having the highest sequence number among one or more respective sequence numbers of the one or more packets 14-X that are to be considered as discarded, not expected, considered as delivered to an upper layer, or considered as received.

In some embodiments, the signaling 22 is included in a data packet with a sequence number, wherein the receiver 16 is to consider as discarded, not expect, consider as delivered to an upper layer, or consider as received each packet that has a sequence number less than the sequence number of the data packet.

In some embodiments, the signaling 22 does not explicitly indicate which one or more packets 14-X are to be considered as discarded, not expected, considered as delivered to an upper layer, or considered as received. In one such embodiment, the receiver 16 is to consider as discarded, not expect, consider as delivered to an upper layer, or consider as received each packet that, as of receipt of the signaling 22, is within a reordering window of the receiver 16.

In some embodiments, the transmitter 12 is a Packet Data Convergence Protocol, PDCP, transmitter, the receiver 16 is a PDCP receiver, and the one or more packets 14-X are one or more PDCP packets.

In some embodiments, the signaling 22 is or is included in a PDCP packet.

In some embodiments, the signaling 22 is or is included in a PDCP control protocol data unit, PDU, and the PDCP control PDU is a type of PDCP control PDU dedicated or specific for indicating that the receiver 16 is to consider as discarded, not expect, consider as delivered to an upper layer, or consider as received one or more packets 14-X.

In some embodiments, the signaling 22 is or is included in a PDCP data PDU. In one embodiment, the PDCP data PDU includes a field that indicates the receiver 16 is to consider as discarded, not expect, consider as delivered to an upper layer, or consider as received one or more packets 14-X. In another embodiment, the PDCP data PDU includes a field that indicates whether one or more sequence numbers indicated by the PDCP data PDU are one or more respective sequence numbers of one or more packets 14-X that the receiver 16 is to consider as discarded, not expect, consider as delivered to an upper layer, or consider as received.

In some embodiments, the method further comprises, based on the signaling 22, considering the one or more packets 14-X as discarded, as delivered to an upper layer, or as received.

In some embodiments, the method further comprises, based on the signaling 22, updating one or more parameters at the receiver 16 to reflect that the one or more packets 14-X are not expected, that the one or more packets 14-X have been received, that the one or more packets 14-X have been discarded, and/or that the one or more packets 14-X have been delivered to an upper layer. In one embodiment, for example, the one or more parameters include an RX_DELIV parameter indicating a sequence number of a next packet to be delivered to an upper layer.

In some embodiments, the method further comprises, based on the signaling 22, updating a reordering window at the receiver 16.

In some embodiments, said waiting comprises waiting to receive the one or more packets 14-X while a reordering timer is running. In one such embodiment, said stopping comprises, responsive to receiving the signaling 22 while the reordering timer is running, stopping waiting to receive the one or more packets 14-X before the reordering timer expires.

Embodiments herein also include corresponding apparatuses. Embodiments herein for instance include a transmitter 12 configured to perform any of the steps of any of the embodiments described above for the transmitter 12.

Embodiments also include a transmitter 12 comprising processing circuitry and power supply circuitry. The processing circuitry is configured to perform any of the steps of any of the embodiments described above for the transmitter 12. The power supply circuitry is configured to supply power to the transmitter 12.

Embodiments further include a transmitter 12 comprising processing circuitry. The processing circuitry is configured to perform any of the steps of any of the embodiments described above for the transmitter 12. In some embodiments, the transmitter 12 further comprises communication circuitry.

Embodiments further include a transmitter 12 comprising processing circuitry and memory. The memory contains instructions executable by the processing circuitry whereby the transmitter 12 is configured to perform any of the steps of any of the embodiments described above for the transmitter 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the transmitter 12 or the receiver 16. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a receiver 16 configured to perform any of the steps of any of the embodiments described above for the receiver 16.

Embodiments also include a receiver 16 comprising processing circuitry and power supply circuitry. The processing circuitry is configured to perform any of the steps of any of the embodiments described above for the receiver 16. The power supply circuitry is configured to supply power to the receiver 16.

Embodiments further include a receiver 16 comprising processing circuitry. The processing circuitry is configured to perform any of the steps of any of the embodiments described above for the receiver 16. In some embodiments, the receiver 16 further comprises communication circuitry.

Embodiments further include a receiver 16 comprising processing circuitry and memory. The memory contains instructions executable by the processing circuitry whereby the receiver 16 is configured to perform any of the steps of any of the embodiments described above for the receiver 16.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

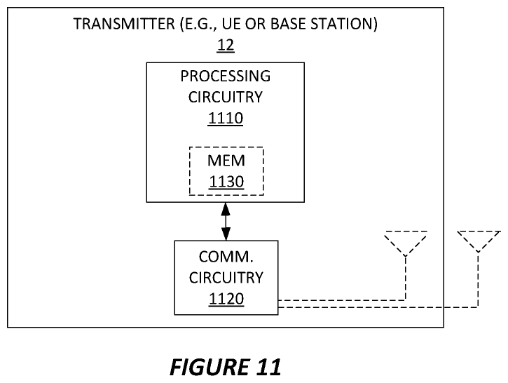

FIG. 11 for example illustrates a transmitter 12 as implemented in accordance with one or more embodiments. As shown, the transmitter 12 includes processing circuitry 1110 and communication circuitry 1120. The communication circuitry 1120 (e.g., radio circuitry) is configured to transmit and/or receive information to and/or from one or more other nodes, e.g., via any communication technology. Such communication may occur via one or more antennas that are either internal or external to the transmitter 12. The processing circuitry 1110 is configured to perform processing described above, e.g., in FIG. 9, such as by executing instructions stored in memory 1130. The processing circuitry 1110 in this regard may implement certain functional means, units, or modules.

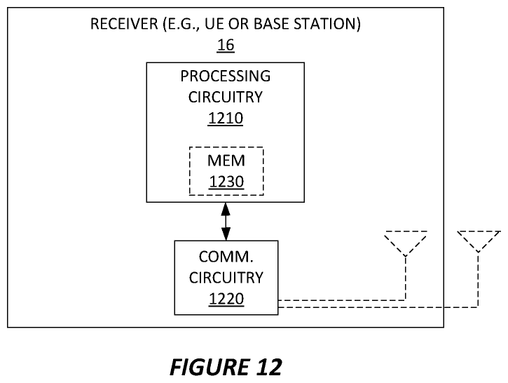

FIG. 12 illustrates a receiver 16 as implemented in accordance with one or more embodiments. As shown, the receiver 16 includes processing circuitry 1210 and communication circuitry 1220. The communication circuitry 1220 is configured to transmit and/or receive information to and/or from one or more other nodes, e.g., via any communication technology. Such communication may occur via one or more antennas that are either internal or external to the receiver 16. The processing circuitry 1210 is configured to perform processing described above, e.g., in FIG. 10, such as by executing instructions stored in memory 1230. The processing circuitry 1210 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

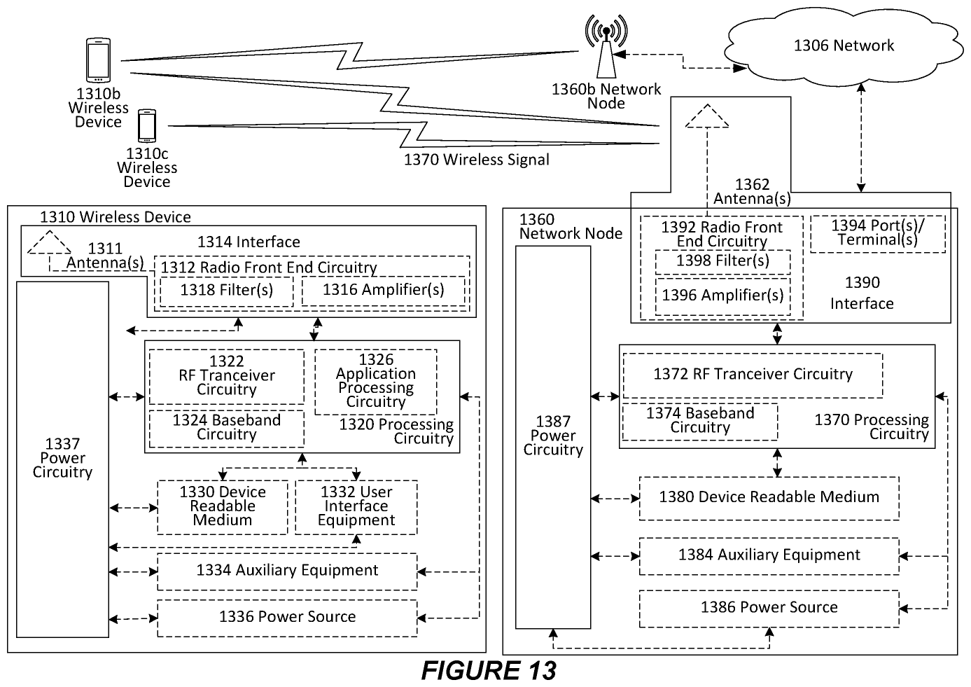

Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 1306, network nodes 1360 and 1360b, and WDs 1310, 1310b, and 1310c. In practice, a wireless network may further include any additional elements suitable to support communication between wireless devices or between a wireless device and another communication device, such as a landline telephone, a service provider, or any other network node or end device. Of the illustrated components, network node 1360 and wireless device (WD) 1310 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1306 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1360 and WD 1310 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 13, network node 1360 includes processing circuitry 1370, device readable medium 1380, interface 1390, auxiliary equipment 1384, power source 1386, power circuitry 1387, and antenna 1362. Although network node 1360 illustrated in the example wireless network of FIG. 13 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1360 are depicted as single boxes located within a larger box, or nested within multiple boxes, in practice, a network node may comprise multiple different physical components that make up a single illustrated component (e.g., device readable medium 1380 may comprise multiple separate hard drives as well as multiple RAM modules).

Similarly, network node 1360 may be composed of multiple physically separate components (e.g., a NodeB component and a RNC component, or a BTS component and a BSC component, etc.), which may each have their own respective components. In certain scenarios in which network node 1360 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1360 may be configured to support multiple radio access technologies (RATs). In such embodiments, some components may be duplicated (e.g., separate device readable medium 1380 for the different RATs) and some components may be reused (e.g., the same antenna 1362 may be shared by the RATs). Network node 1360 may also include multiple sets of the various illustrated components for different wireless technologies integrated into network node 1360, such as, for example, GSM, WCDMA, LTE, NR, WiFi, or Bluetooth wireless technologies. These wireless technologies may be integrated into the same or different chip or set of chips and other components within network node 1360.

Processing circuitry 1370 is configured to perform any determining, calculating, or similar operations (e.g., certain obtaining operations) described herein as being provided by a network node. These operations performed by processing circuitry 1370 may include processing information obtained by processing circuitry 1370 by, for example, converting the obtained information into other information, comparing the obtained information or converted information to information stored in the network node, and/or performing one or more operations based on the obtained information or converted information, and as a result of said processing making a determination.

Processing circuitry 1370 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1360 components, such as device readable medium 1380, network node 1360 functionality. For example, processing circuitry 1370 may execute instructions stored in device readable medium 1380 or in memory within processing circuitry 1370. Such functionality may include providing any of the various wireless features, functions, or benefits discussed herein. In some embodiments, processing circuitry 1370 may include a system on a chip (SOC).

In some embodiments, processing circuitry 1370 may include one or more of radio frequency (RF) transceiver circuitry 1372 and baseband processing circuitry 1374. In some embodiments, radio frequency (RF) transceiver circuitry 1372 and baseband processing circuitry 1374 may be on separate chips (or sets of chips), boards, or units, such as radio units and digital units. In alternative embodiments, part or all of RF transceiver circuitry 1372 and baseband processing circuitry 1374 may be on the same chip or set of chips, boards, or units

In certain embodiments, some or all of the functionality described herein as being provided by a network node, base station, eNB or other such network device may be performed by processing circuitry 1370 executing instructions stored on device readable medium 1380 or memory within processing circuitry 1370. In alternative embodiments, some or all of the functionality may be provided by processing circuitry 1370 without executing instructions stored on a separate or discrete device readable medium, such as in a hard-wired manner. In any of those embodiments, whether executing instructions stored on a device readable storage medium or not, processing circuitry 1370 can be configured to perform the described functionality. The benefits provided by such functionality are not limited to processing circuitry 1370 alone or to other components of network node 1360, but are enjoyed by network node 1360 as a whole, and/or by end users and the wireless network generally.

Device readable medium 1380 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1370. Device readable medium 1380 may store any suitable instructions, data or information, including a computer program, software, an application including one or more of logic, rules, code, tables, etc. and/or other instructions capable of being executed by processing circuitry 1370 and, utilized by network node 1360. Device readable medium 1380 may be used to store any calculations made by processing circuitry 1370 and/or any data received via interface 1390. In some embodiments, processing circuitry 1370 and device readable medium 1380 may be considered to be integrated.

Interface 1390 is used in the wired or wireless communication of signalling and/or data between network node 1360, network 1306, and/or WDs 1310. As illustrated, interface 1390 comprises port(s)/terminal(s) 1394 to send and receive data, for example to and from network 1306 over a wired connection. Interface 1390 also includes radio front end circuitry 1392 that may be coupled to, or in certain embodiments a part of, antenna 1362. Radio front end circuitry 1392 comprises filters 1398 and amplifiers 1396. Radio front end circuitry 1392 may be connected to antenna 1362 and processing circuitry 1370. Radio front end circuitry may be configured to condition signals communicated between antenna 1362 and processing circuitry 1370. Radio front end circuitry 1392 may receive digital data that is to be sent out to other network nodes or WDs via a wireless connection. Radio front end circuitry 1392 may convert the digital data into a radio signal having the appropriate channel and bandwidth parameters using a combination of filters 1398 and/or amplifiers 1396. The radio signal may then be transmitted via antenna 1362. Similarly, when receiving data, antenna 1362 may collect radio signals which are then converted into digital data by radio front end circuitry 1392. The digital data may be passed to processing circuitry 1370. In other embodiments, the interface may comprise different components and/or different combinations of components.

In certain alternative embodiments, network node 1360 may not include separate radio front end circuitry 1392, instead, processing circuitry 1370 may comprise radio front end circuitry and may be connected to antenna 1362 without separate radio front end circuitry 1392. Similarly, in some embodiments, all or some of RF transceiver circuitry 1372 may be considered a part of interface 1390. In still other embodiments, interface 1390 may include one or more ports or terminals 1394, radio front end circuitry 1392, and RF transceiver circuitry 1372, as part of a radio unit (not shown), and interface 1390 may communicate with baseband processing circuitry 1374, which is part of a digital unit (not shown).

Antenna 1362 may include one or more antennas, or antenna arrays, configured to send and/or receive wireless signals. Antenna 1362 may be coupled to radio front end circuitry 1390 and may be any type of antenna capable of transmitting and receiving data and/or signals wirelessly. In some embodiments, antenna 1362 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1362 may be separate from network node 1360 and may be connectable to network node 1360 through an interface or port.

Antenna 1362, interface 1390, and/or processing circuitry 1370 may be configured to perform any receiving operations and/or certain obtaining operations described herein as being performed by a network node. Any information, data and/or signals may be received from a wireless device, another network node and/or any other network equipment. Similarly, antenna 1362, interface 1390, and/or processing circuitry 1370 may be configured to perform any transmitting operations described herein as being performed by a network node. Any information, data and/or signals may be transmitted to a wireless device, another network node and/or any other network equipment.

Power circuitry 1387 may comprise, or be coupled to, power management circuitry and is configured to supply the components of network node 1360 with power for performing the functionality described herein. Power circuitry 1387 may receive power from power source 1386. Power source 1386 and/or power circuitry 1387 may be configured to provide power to the various components of network node 1360 in a form suitable for the respective components (e.g., at a voltage and current level needed for each respective component). Power source 1386 may either be included in, or external to, power circuitry 1387 and/or network node 1360. For example, network node 1360 may be connectable to an external power source (e.g., an electricity outlet) via an input circuitry or interface such as an electrical cable, whereby the external power source supplies power to power circuitry 1387. As a further example, power source 1386 may comprise a source of power in the form of a battery or battery pack which is connected to, or integrated in, power circuitry 1387. The battery may provide backup power should the external power source fail. Other types of power sources, such as photovoltaic devices, may also be used.

Alternative embodiments of network node 1360 may include additional components beyond those shown in FIG. 13 that may be responsible for providing certain aspects of the network node's functionality, including any of the functionality described herein and/or any functionality necessary to support the subject matter described herein. For example, network node 1360 may include user interface equipment to allow input of information into network node 1360 and to allow output of information from network node 1360. This may allow a user to perform diagnostic, maintenance, repair, and other administrative functions for network node 1360.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (Vol P) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1310 includes antenna 1311, interface 1314, processing circuitry 1320, device readable medium 1330, user interface equipment 1332, auxiliary equipment 1334, power source 1336 and power circuitry 1337. WD 1310 may include multiple sets of one or more of the illustrated components for different wireless technologies supported by WD 1310, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1310.

Antenna 1311 may include one or more antennas or antenna arrays, configured to send and/or receive wireless signals, and is connected to interface 1314. In certain alternative embodiments, antenna 1311 may be separate from WD 1310 and be connectable to WD 1310 through an interface or port. Antenna 1311, interface 1314, and/or processing circuitry 1320 may be configured to perform any receiving or transmitting operations described herein as being performed by a WD. Any information, data and/or signals may be received from a network node and/or another WD. In some embodiments, radio front end circuitry and/or antenna 1311 may be considered an interface.

As illustrated, interface 1314 comprises radio front end circuitry 1312 and antenna 1311. Radio front end circuitry 1312 comprise one or more filters 1318 and amplifiers 1316. Radio front end circuitry 1314 is connected to antenna 1311 and processing circuitry 1320, and is configured to condition signals communicated between antenna 1311 and processing circuitry 1320. Radio front end circuitry 1312 may be coupled to or a part of antenna 1311. In some embodiments, WD 1310 may not include separate radio front end circuitry 1312; rather, processing circuitry 1320 may comprise radio front end circuitry and may be connected to antenna 1311. Similarly, in some embodiments, some or all of RF transceiver circuitry 1322 may be considered a part of interface 1314. Radio front end circuitry 1312 may receive digital data that is to be sent out to other network nodes or WDs via a wireless connection. Radio front end circuitry 1312 may convert the digital data into a radio signal having the appropriate channel and bandwidth parameters using a combination of filters 1318 and/or amplifiers 1316. The radio signal may then be transmitted via antenna 1311. Similarly, when receiving data, antenna 1311 may collect radio signals which are then converted into digital data by radio front end circuitry 1312. The digital data may be passed to processing circuitry 1320. In other embodiments, the interface may comprise different components and/or different combinations of components.

Processing circuitry 1320 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1310 components, such as device readable medium 1330, WD 1310 functionality. Such functionality may include providing any of the various wireless features or benefits discussed herein. For example, processing circuitry 1320 may execute instructions stored in device readable medium 1330 or in memory within processing circuitry 1320 to provide the functionality disclosed herein.

As illustrated, processing circuitry 1320 includes one or more of RF transceiver circuitry 1322, baseband processing circuitry 1324, and application processing circuitry 1326. In other embodiments, the processing circuitry may comprise different components and/or different combinations of components. In certain embodiments processing circuitry 1320 of WD 1310 may comprise a SOC. In some embodiments, RF transceiver circuitry 1322, baseband processing circuitry 1324, and application processing circuitry 1326 may be on separate chips or sets of chips. In alternative embodiments, part or all of baseband processing circuitry 1324 and application processing circuitry 1326 may be combined into one chip or set of chips, and RF transceiver circuitry 1322 may be on a separate chip or set of chips. In still alternative embodiments, part or all of RF transceiver circuitry 1322 and baseband processing circuitry 1324 may be on the same chip or set of chips, and application processing circuitry 1326 may be on a separate chip or set of chips. In yet other alternative embodiments, part or all of RF transceiver circuitry 1322, baseband processing circuitry 1324, and application processing circuitry 1326 may be combined in the same chip or set of chips. In some embodiments, RF transceiver circuitry 1322 may be a part of interface 1314. RF transceiver circuitry 1322 may condition RF signals for processing circuitry 1320.

In certain embodiments, some or all of the functionality described herein as being performed by a WD may be provided by processing circuitry 1320 executing instructions stored on device readable medium 1330, which in certain embodiments may be a computer-readable storage medium. In alternative embodiments, some or all of the functionality may be provided by processing circuitry 1320 without executing instructions stored on a separate or discrete device readable storage medium, such as in a hard-wired manner. In any of those particular embodiments, whether executing instructions stored on a device readable storage medium or not, processing circuitry 1320 can be configured to perform the described functionality. The benefits provided by such functionality are not limited to processing circuitry 1320 alone or to other components of WD 1310, but are enjoyed by WD 1310 as a whole, and/or by end users and the wireless network generally.

Processing circuitry 1320 may be configured to perform any determining, calculating, or similar operations (e.g., certain obtaining operations) described herein as being performed by a WD. These operations, as performed by processing circuitry 1320, may include processing information obtained by processing circuitry 1320 by, for example, converting the obtained information into other information, comparing the obtained information or converted information to information stored by WD 1310, and/or performing one or more operations based on the obtained information or converted information, and as a result of said processing making a determination.

Device readable medium 1330 may be operable to store a computer program, software, an application including one or more of logic, rules, code, tables, etc. and/or other instructions capable of being executed by processing circuitry 1320. Device readable medium 1330 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1320. In some embodiments, processing circuitry 1320 and device readable medium 1330 may be considered to be integrated.

User interface equipment 1332 may provide components that allow for a human user to interact with WD 1310. Such interaction may be of many forms, such as visual, audial, tactile, etc. User interface equipment 1332 may be operable to produce output to the user and to allow the user to provide input to WD 1310. The type of interaction may vary depending on the type of user interface equipment 1332 installed in WD 1310. For example, if WD 1310 is a smart phone, the interaction may be via a touch screen; if WD 1310 is a smart meter, the interaction may be through a screen that provides usage (e.g., the number of gallons used) or a speaker that provides an audible alert (e.g., if smoke is detected). User interface equipment 1332 may include input interfaces, devices and circuits, and output interfaces, devices and circuits. User interface equipment 1332 is configured to allow input of information into WD 1310, and is connected to processing circuitry 1320 to allow processing circuitry 1320 to process the input information. User interface equipment 1332 may include, for example, a microphone, a proximity or other sensor, keys/buttons, a touch display, one or more cameras, a USB port, or other input circuitry. User interface equipment 1332 is also configured to allow output of information from WD 1310, and to allow processing circuitry 1320 to output information from WD 1310. User interface equipment 1332 may include, for example, a speaker, a display, vibrating circuitry, a USB port, a headphone interface, or other output circuitry. Using one or more input and output interfaces, devices, and circuits, of user interface equipment 1332, WD 1310 may communicate with end users and/or the wireless network, and allow them to benefit from the functionality described herein.

Auxiliary equipment 1334 is operable to provide more specific functionality which may not be generally performed by WDs. This may comprise specialized sensors for doing measurements for various purposes, interfaces for additional types of communication such as wired communications etc. The inclusion and type of components of auxiliary equipment 1334 may vary depending on the embodiment and/or scenario.

Power source 1336 may, in some embodiments, be in the form of a battery or battery pack. Other types of power sources, such as an external power source (e.g., an electricity outlet), photovoltaic devices or power cells, may also be used. WD 1310 may further comprise power circuitry 1337 for delivering power from power source 1336 to the various parts of WD 1310 which need power from power source 1336 to carry out any functionality described or indicated herein. Power circuitry 1337 may in certain embodiments comprise power management circuitry. Power circuitry 1337 may additionally or alternatively be operable to receive power from an external power source; in which case WD 1310 may be connectable to the external power source (such as an electricity outlet) via input circuitry or an interface such as an electrical power cable. Power circuitry 1337 may also in certain embodiments be operable to deliver power from an external power source to power source 1336. This may be, for example, for the charging of power source 1336. Power circuitry 1337 may perform any formatting, converting, or other modification to the power from power source 1336 to make the power suitable for the respective components of WD 1310 to which power is supplied.

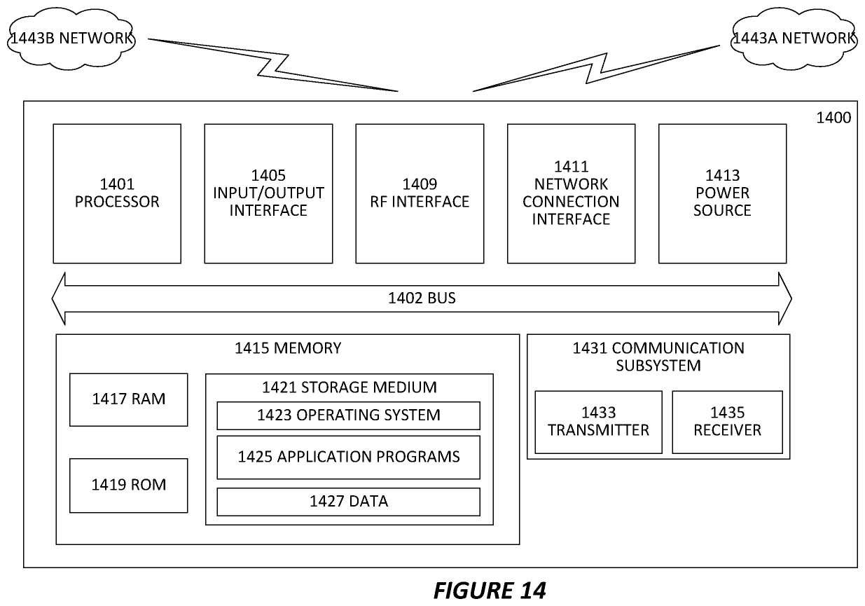

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 14200 may be any UE identified by the 3^{rd} Generation Partnership Project (3GPP), including a NB-IoT UE, a machine type communication (MTC) UE, and/or an enhanced MTC (eMTC) UE. UE 1400, as illustrated in FIG. 14, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 14 is a UE, the components discussed herein are equally applicable to a WD, and vice-versa.

In FIG. 14, UE 1400 includes processing circuitry 1401 that is operatively coupled to input/output interface 1405, radio frequency (RF) interface 1409, network connection interface 1411, memory 1415 including random access memory (RAM) 1417, read-only memory (ROM) 1419, and storage medium 1421 or the like, communication subsystem 1431, power source 1433, and/or any other component, or any combination thereof. Storage medium 1421 includes operating system 1423, application program 1425, and data 1427. In other embodiments, storage medium 1421 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 1401 may be configured to process computer instructions and data. Processing circuitry 1401 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1401 may include two central processing units (CPUs). Data may be information in a form suitable for use by a computer.

In the depicted embodiment, input/output interface 1405 may be configured to provide a communication interface to an input device, output device, or input and output device. UE 1400 may be configured to use an output device via input/output interface 1405. An output device may use the same type of interface port as an input device. For example, a USB port may be used to provide input to and output from UE 1400. The output device may be a speaker, a sound card, a video card, a display, a monitor, a printer, an actuator, an emitter, a smartcard, another output device, or any combination thereof. UE 1400 may be configured to use an input device via input/output interface 1405 to allow a user to capture information into UE 1400. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 1409 may be configured to provide a communication interface to RF components such as a transmitter, a receiver, and an antenna. Network connection interface 1411 may be configured to provide a communication interface to network 1443a. Network 1443a may encompass wired and/or wireless networks such as a local-area network (LAN), a wide-area network (WAN), a computer network, a wireless network, a telecommunications network, another like network or any combination thereof. For example, network 1443a may comprise a Wi-Fi network. Network connection interface 1411 may be configured to include a receiver and a transmitter interface used to communicate with one or more other devices over a communication network according to one or more communication protocols, such as Ethernet, TCP/IP, SONET, ATM, or the like. Network connection interface 1411 may implement receiver and transmitter functionality appropriate to the communication network links (e.g., optical, electrical, and the like). The transmitter and receiver functions may share circuit components, software or firmware, or alternatively may be implemented separately.

RAM 1417 may be configured to interface via bus 1402 to processing circuitry 1401 to provide storage or caching of data or computer instructions during the execution of software programs such as the operating system, application programs, and device drivers. ROM 1419 may be configured to provide computer instructions or data to processing circuitry 1401. For example, ROM 1419 may be configured to store invariant low-level system code or data for basic system functions such as basic input and output (I/O), startup, or reception of keystrokes from a keyboard that are stored in a non-volatile memory. Storage medium 1421 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1421 may be configured to include operating system 1423, application program 1425 such as a web browser application, a widget or gadget engine or another application, and data file 1427. Storage medium 1421 may store, for use by UE 1400, any of a variety of various operating systems or combinations of operating systems.

Storage medium 1421 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1421 may allow UE 1400 to access computer-executable instructions, application programs or the like, stored on transitory or non-transitory memory media, to off-load data, or to upload data. An article of manufacture, such as one utilizing a communication system may be tangibly embodied in storage medium 1421, which may comprise a device readable medium.

In FIG. 14, processing circuitry 1401 may be configured to communicate with network 1443b using communication subsystem 1431. Network 1443a and network 1443b may be the same network or networks or different network or networks. Communication subsystem 1431 may be configured to include one or more transceivers used to communicate with network 1443b. For example, communication subsystem 1431 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1433 and/or receiver 1435 to implement transmitter or receiver functionality, respectively, appropriate to the RAN links (e.g., frequency allocations and the like). Further, transmitter 1433 and receiver 1435 of each transceiver may share circuit components, software or firmware, or alternatively may be implemented separately.

In the illustrated embodiment, the communication functions of communication subsystem 1431 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1431 may include cellular communication, Wi-Fi communication, Bluetooth communication, and GPS communication. Network 1443b may encompass wired and/or wireless networks such as a local-area network (LAN), a wide-area network (WAN), a computer network, a wireless network, a telecommunications network, another like network or any combination thereof. For example, network 1443b may be a cellular network, a Wi-Fi network, and/or a near-field network. Power source 1413 may be configured to provide alternating current (AC) or direct current (DC) power to components of UE 1400.

The features, benefits and/or functions described herein may be implemented in one of the components of UE 1400 or partitioned across multiple components of UE 1400. Further, the features, benefits, and/or functions described herein may be implemented in any combination of hardware, software or firmware. In one example, communication subsystem 1431 may be configured to include any of the components described herein. Further, processing circuitry 1401 may be configured to communicate with any of such components over bus 1402. In another example, any of such components may be represented by program instructions stored in memory that when executed by processing circuitry 1401 perform the corresponding functions described herein. In another example, the functionality of any of such components may be partitioned between processing circuitry 1401 and communication subsystem 1431. In another example, the non-computationally intensive functions of any of such components may be implemented in software or firmware and the computationally intensive functions may be implemented in hardware.

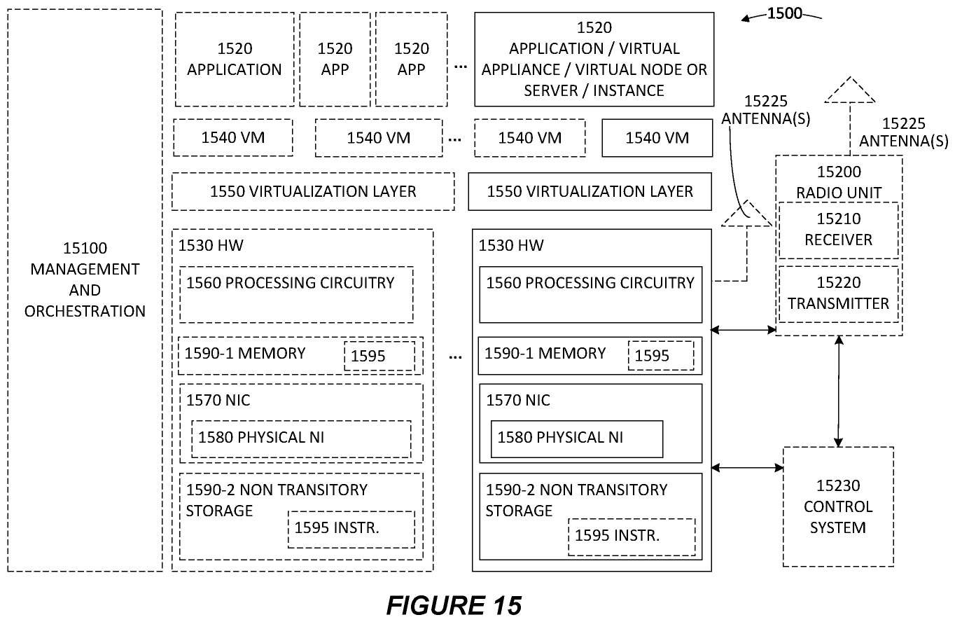

FIG. 15 is a schematic block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1500 hosted by one or more of hardware nodes 1530. Further, in embodiments in which the virtual node is not a radio access node or does not require radio connectivity (e.g., a core network node), then the network node may be entirely virtualized.

The functions may be implemented by one or more applications 1520 (which may alternatively be called software instances, virtual appliances, network functions, virtual nodes, virtual network functions, etc.) operative to implement some of the features, functions, and/or benefits of some of the embodiments disclosed herein. Applications 1520 are run in virtualization environment 1500 which provides hardware 1530 comprising processing circuitry 1560 and memory 1590. Memory 1590 contains instructions 1595 executable by processing circuitry 1560 whereby application 1520 is operative to provide one or more of the features, benefits, and/or functions disclosed herein.

Virtualization environment 1500, comprises general-purpose or special-purpose network hardware devices 1530 comprising a set of one or more processors or processing circuitry 1560, which may be commercial off-the-shelf (COTS) processors, dedicated Application Specific Integrated Circuits (ASICs), or any other type of processing circuitry including digital or analog hardware components or special purpose processors. Each hardware device may comprise memory 1590-1 which may be non-persistent memory for temporarily storing instructions 1595 or software executed by processing circuitry 1560. Each hardware device may comprise one or more network interface controllers (NICs) 1570, also known as network interface cards, which include physical network interface 1580. Each hardware device may also include non-transitory, persistent, machine-readable storage media 1590-2 having stored therein software 1595 and/or instructions executable by processing circuitry 1560. Software 1595 may include any type of software including software for instantiating one or more virtualization layers 1550 (also referred to as hypervisors), software to execute virtual machines 1540 as well as software allowing it to execute functions, features and/or benefits described in relation with some embodiments described herein.

Virtual machines 1540, comprise virtual processing, virtual memory, virtual networking or interface and virtual storage, and may be run by a corresponding virtualization layer 1550 or hypervisor. Different embodiments of the instance of virtual appliance 1520 may be implemented on one or more of virtual machines 1540, and the implementations may be made in different ways.

During operation, processing circuitry 1560 executes software 1595 to instantiate the hypervisor or virtualization layer 1550, which may sometimes be referred to as a virtual machine monitor (VMM). Virtualization layer 1550 may present a virtual operating platform that appears like networking hardware to virtual machine 1540.

As shown in FIG. 15, hardware 1530 may be a standalone network node with generic or specific components. Hardware 1530 may comprise antenna 15225 and may implement some functions via virtualization. Alternatively, hardware 1530 may be part of a larger cluster of hardware (e.g. such as in a data center or customer premise equipment (CPE)) where many hardware nodes work together and are managed via management and orchestration (MANO) 15100, which, among others, oversees lifecycle management of applications 1520.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1540 may be a software implementation of a physical machine that runs programs as if they were executing on a physical, non-virtualized machine. Each of virtual machines 1540, and that part of hardware 1530 that executes that virtual machine, be it hardware dedicated to that virtual machine and/or hardware shared by that virtual machine with others of the virtual machines 1540, forms a separate virtual network elements (VNE).

Still in the context of NFV, Virtual Network Function (VNF) is responsible for handling specific network functions that run in one or more virtual machines 1540 on top of hardware networking infrastructure 1530 and corresponds to application 1520 in FIG. 15.

In some embodiments, one or more radio units 15200 that each include one or more transmitters 15220 and one or more receivers 15210 may be coupled to one or more antennas 15225. Radio units 15200 may communicate directly with hardware nodes 1530 via one or more appropriate network interfaces and may be used in combination with the virtual components to provide a virtual node with radio capabilities, such as a radio access node or a base station.

In some embodiments, some signalling can be effected with the use of control system 15230 which may alternatively be used for communication between the hardware nodes 1530 and radio units 15200.

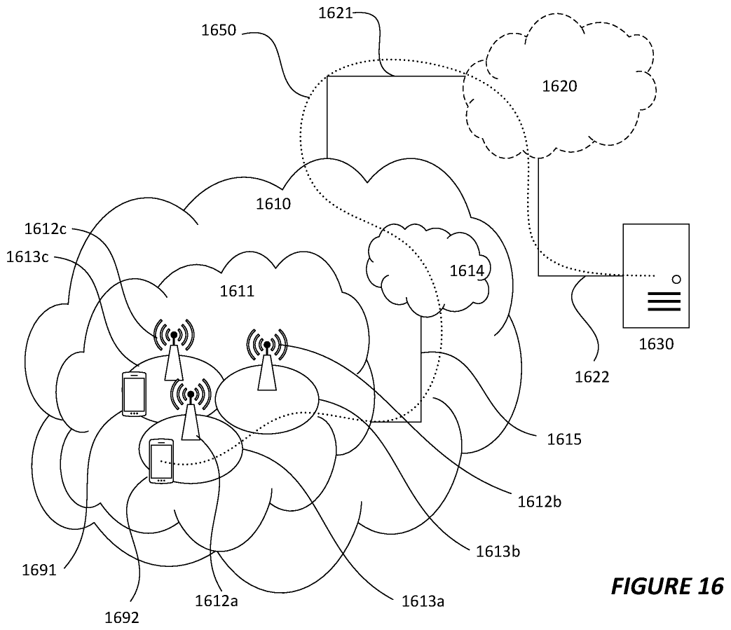

FIG. 16 illustrates a telecommunication network connected via an intermediate network to a host computer in accordance with some embodiments. In particular, with reference to FIG. 16, in accordance with an embodiment, a communication system includes telecommunication network 1610, such as a 3GPP-type cellular network, which comprises access network 1611, such as a radio access network, and core network 1614. Access network 1611 comprises a plurality of base stations 1612a, 1612b, 1612c, such as NBs, eNBs, gNBs or other types of wireless access points, each defining a corresponding coverage area 1613a, 1613b, 1613c. Each base station 1612a, 1612b, 1612c is connectable to core network 1614 over a wired or wireless connection 1615. A first UE 1691 located in coverage area 1613c is configured to wirelessly connect to, or be paged by, the corresponding base station 1612c. A second UE 1692 in coverage area 1613a is wirelessly connectable to the corresponding base station 1612a. While a plurality of UEs 1691, 1692 are illustrated in this example, the disclosed embodiments are equally applicable to a situation where a sole UE is in the coverage area or where a sole UE is connecting to the corresponding base station 1612.

Telecommunication network 1610 is itself connected to host computer 1630, which may be embodied in the hardware and/or software of a standalone server, a cloud-implemented server, a distributed server or as processing resources in a server farm. Host computer 1630 may be under the ownership or control of a service provider, or may be operated by the service provider or on behalf of the service provider. Connections 1621 and 1622 between telecommunication network 1610 and host computer 1630 may extend directly from core network 1614 to host computer 1630 or may go via an optional intermediate network 1620. Intermediate network 1620 may be one of, or a combination of more than one of, a public, private or hosted network; intermediate network 1620, if any, may be a backbone network or the Internet; in particular, intermediate network 1620 may comprise two or more sub-networks (not shown).

The communication system of FIG. 16 as a whole enables connectivity between the connected UEs 1691, 1692 and host computer 1630. The connectivity may be described as an over-the-top (OTT) connection 1650. Host computer 1630 and the connected UEs 1691, 1692 are configured to communicate data and/or signaling via OTT connection 1650, using access network 1611, core network 1614, any intermediate network 1620 and possible further infrastructure (not shown) as intermediaries. OTT connection 1650 may be transparent in the sense that the participating communication devices through which OTT connection 1650 passes are unaware of routing of uplink and downlink communications. For example, base station 1612 may not or need not be informed about the past routing of an incoming downlink communication with data originating from host computer 1630 to be forwarded (e.g., handed over) to a connected UE 1691. Similarly, base station 1612 need not be aware of the future routing of an outgoing uplink communication originating from the UE 1691 towards the host computer 1630.

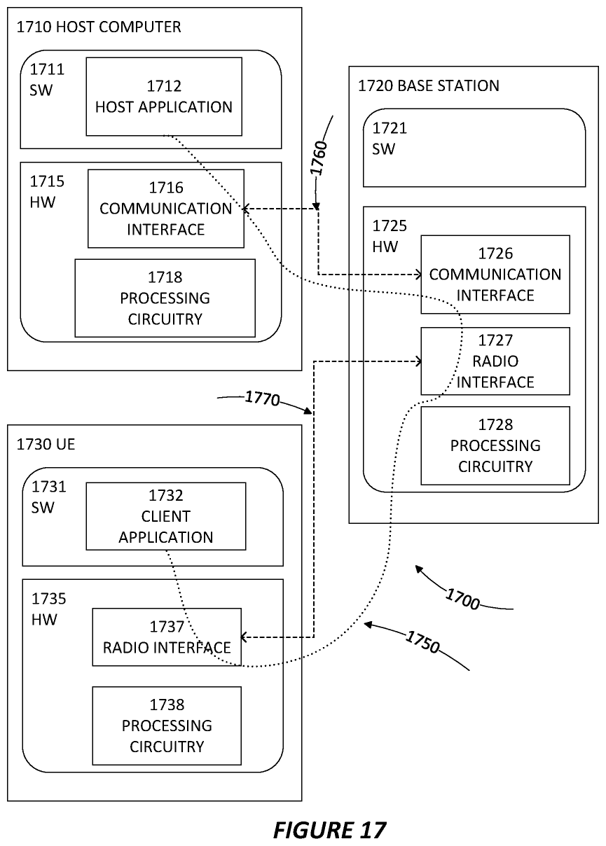

Example implementations, in accordance with an embodiment, of the UE, base station and host computer discussed in the preceding paragraphs will now be described with reference to FIG. 17. FIG. 17 illustrates host computer communicating via a base station with a user equipment over a partially wireless connection in accordance with some embodiments In communication system 1700, host computer 1710 comprises hardware 1715 including communication interface 1716 configured to set up and maintain a wired or wireless connection with an interface of a different communication device of communication system 1700. Host computer 1710 further comprises processing circuitry 1718, which may have storage and/or processing capabilities. In particular, processing circuitry 1718 may comprise one or more programmable processors, application-specific integrated circuits, field programmable gate arrays or combinations of these (not shown) adapted to execute instructions. Host computer 1710 further comprises software 1711, which is stored in or accessible by host computer 1710 and executable by processing circuitry 1718. Software 1711 includes host application 1712. Host application 1712 may be operable to provide a service to a remote user, such as UE 1730 connecting via OTT connection 1750 terminating at UE 1730 and host computer 1710. In providing the service to the remote user, host application 1712 may provide user data which is transmitted using OTT connection 1750.

Communication system 1700 further includes base station 1720 provided in a telecommunication system and comprising hardware 1725 enabling it to communicate with host computer 1710 and with UE 1730. Hardware 1725 may include communication interface 1726 for setting up and maintaining a wired or wireless connection with an interface of a different communication device of communication system 1700, as well as radio interface 1727 for setting up and maintaining at least wireless connection 1770 with UE 1730 located in a coverage area (not shown in FIG. 17) served by base station 1720. Communication interface 1726 may be configured to facilitate connection 1760 to host computer 1710. Connection 1760 may be direct or it may pass through a core network (not shown in FIG. 17) of the telecommunication system and/or through one or more intermediate networks outside the telecommunication system. In the embodiment shown, hardware 1725 of base station 1720 further includes processing circuitry 1728, which may comprise one or more programmable processors, application-specific integrated circuits, field programmable gate arrays or combinations of these (not shown) adapted to execute instructions. Base station 1720 further has software 1721 stored internally or accessible via an external connection.

Communication system 1700 further includes UE 1730 already referred to. Its hardware 1735 may include radio interface 1737 configured to set up and maintain wireless connection 1770 with a base station serving a coverage area in which UE 1730 is currently located. Hardware 1735 of UE 1730 further includes processing circuitry 1738, which may comprise one or more programmable processors, application-specific integrated circuits, field programmable gate arrays or combinations of these (not shown) adapted to execute instructions. UE 1730 further comprises software 1731, which is stored in or accessible by UE 1730 and executable by processing circuitry 1738. Software 1731 includes client application 1732. Client application 1732 may be operable to provide a service to a human or non-human user via UE 1730, with the support of host computer 1710. In host computer 1710, an executing host application 1712 may communicate with the executing client application 1732 via OTT connection 1750 terminating at UE 1730 and host computer 1710. In providing the service to the user, client application 1732 may receive request data from host application 1712 and provide user data in response to the request data. OTT connection 1750 may transfer both the request data and the user data. Client application 1732 may interact with the user to generate the user data that it provides.

It is noted that host computer 1710, base station 1720 and UE 1730 illustrated in FIG. 17 may be similar or identical to host computer 1630, one of base stations 1612a, 1612b, 1612c and one of UEs 1691, 1692 of FIG. 16, respectively. This is to say, the inner workings of these entities may be as shown in FIG. 17 and independently, the surrounding network topology may be that of FIG. 16.

In FIG. 17, OTT connection 1750 has been drawn abstractly to illustrate the communication between host computer 1710 and UE 1730 via base station 1720, without explicit reference to any intermediary devices and the precise routing of messages via these devices. Network infrastructure may determine the routing, which it may be configured to hide from UE 1730 or from the service provider operating host computer 1710, or both. While OTT connection 1750 is active, the network infrastructure may further take decisions by which it dynamically changes the routing (e.g., on the basis of load balancing consideration or reconfiguration of the network).

Wireless connection 1770 between UE 1730 and base station 1720 is in accordance with the teachings of the embodiments described throughout this disclosure. One or more of the various embodiments improve the performance of OTT services provided to UE 1730 using OTT connection 1750, in which wireless connection 1770 forms the last segment.

A measurement procedure may be provided for the purpose of monitoring data rate, latency and other factors on which the one or more embodiments improve. There may further be an optional network functionality for reconfiguring OTT connection 1750 between host computer 1710 and UE 1730, in response to variations in the measurement results. The measurement procedure and/or the network functionality for reconfiguring OTT connection 1750 may be implemented in software 1711 and hardware 1715 of host computer 1710 or in software 1731 and hardware 1735 of UE 1730, or both. In embodiments, sensors (not shown) may be deployed in or in association with communication devices through which OTT connection 1750 passes; the sensors may participate in the measurement procedure by supplying values of the monitored quantities exemplified above, or supplying values of other physical quantities from which software 1711, 1731 may compute or estimate the monitored quantities. The reconfiguring of OTT connection 1750 may include message format, retransmission settings, preferred routing etc.; the reconfiguring need not affect base station 1720, and it may be unknown or imperceptible to base station 1720. Such procedures and functionalities may be known and practiced in the art. In certain embodiments, measurements may involve proprietary UE signaling facilitating host computer 1710's measurements of throughput, propagation times, latency and the like. The measurements may be implemented in that software 1711 and 1731 causes messages to be transmitted, in particular empty or ‘dummy’ messages, using OTT connection 1750 while it monitors propagation times, errors etc.

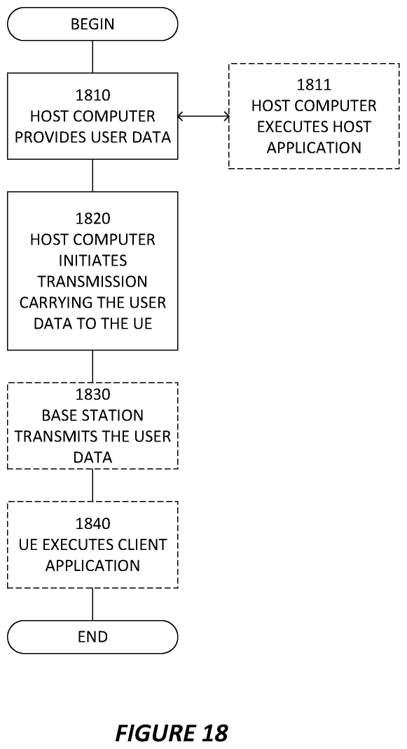

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In step 1810, the host computer provides user data. In substep 1811 (which may be optional) of step 1810, the host computer provides the user data by executing a host application. In step 1820, the host computer initiates a transmission carrying the user data to the UE. In step 1830 (which may be optional), the base station transmits to the UE the user data which was carried in the transmission that the host computer initiated, in accordance with the teachings of the embodiments described throughout this disclosure. In step 1840 (which may also be optional), the UE executes a client application associated with the host application executed by the host computer.

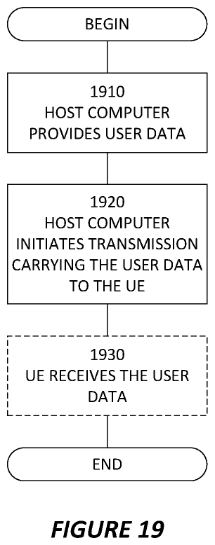

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In step 1910 of the method, the host computer provides user data. In an optional substep (not shown) the host computer provides the user data by executing a host application. In step 1920, the host computer initiates a transmission carrying the user data to the UE. The transmission may pass via the base station, in accordance with the teachings of the embodiments described throughout this disclosure. In step 1930 (which may be optional), the UE receives the user data carried in the transmission.

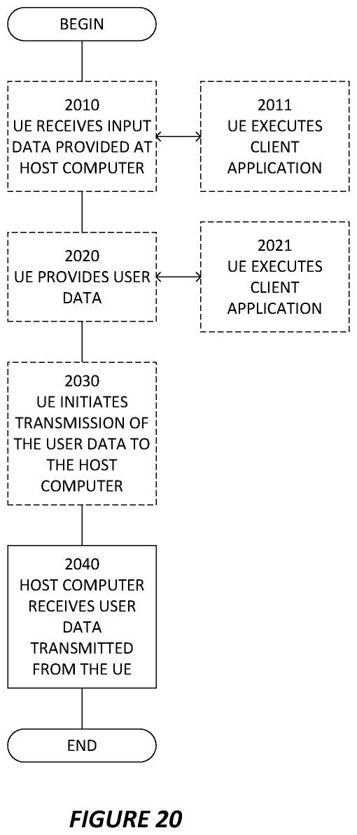

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In step 2010 (which may be optional), the UE receives input data provided by the host computer. Additionally or alternatively, in step 2020, the UE provides user data. In substep 2021 (which may be optional) of step 2020, the UE provides the user data by executing a client application. In substep 2011 (which may be optional) of step 2010, the UE executes a client application which provides the user data in reaction to the received input data provided by the host computer. In providing the user data, the executed client application may further consider user input received from the user. Regardless of the specific manner in which the user data was provided, the UE initiates, in substep 2030 (which may be optional), transmission of the user data to the host computer. In step 2040 of the method, the host computer receives the user data transmitted from the UE, in accordance with the teachings of the embodiments described throughout this disclosure.

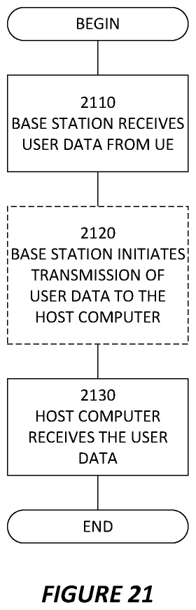

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In step 2110 (which may be optional), in accordance with the teachings of the embodiments described throughout this disclosure, the base station receives user data from the UE. In step 2120 (which may be optional), the base station initiates transmission of the received user data to the host computer. In step 2130 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a transmitter configured for use in a wireless communication network, the method comprising:
transmitting, to a receiver, signaling indicating that the receiver is to consider as discarded, not expect, consider as delivered to an upper layer, or consider as received one or more packets.

A2. The method of embodiment A1, wherein the transmitter is a Packet Data Convergence Protocol, PDCP, transmitter, the receiver is a PDCP receiver, and the one or more packets are one or more PDCP packets.

A3. The method of any of embodiments A1-A2, wherein the signaling is or is included in a PDCP packet.

A4. The method of any of embodiments A1-A3, wherein the signaling is or is included in a PDCP control protocol data unit, PDU.

A5. The method of embodiment A4, wherein the PDCP control PDU is a type of PDCP control PDU dedicated or specific for indicating that the receiver is to consider as discarded, not expect, consider as delivered to an upper layer, or consider as received one or more packets.

A6. The method of any of embodiments A1-A3, wherein the signaling is or is included in a PDCP data PDU.

A7. The method of embodiment A6, wherein the PDCP data PDU includes a field that indicates the receiver is to consider as discarded, not expect, consider as delivered to an upper layer, or consider as received one or more packets.

A8. The method of embodiment A6, wherein the PDCP data PDU includes a field that indicates whether one or more sequence numbers indicated by the PDCP data PDU are one or more respective sequence numbers of one or more packets that the receiver is to consider as discarded, not expect, consider as delivered to an upper layer, or consider as received.

A9. The method of any of embodiments A1-A8, wherein the signaling indicates which one or more packets are to be considered as discarded, not expected, considered as delivered to an upper layer, or considered as received by explicitly indicating each of one or more respective sequence numbers of the one or more packets.

A10. The method of any of embodiments A1-A8, wherein the signaling indicates which one or more packets are to be considered as discarded, not expected, considered as delivered to an upper layer, or considered as received by explicitly indicating a sequence number of a packet having the highest sequence number among one or more respective sequence numbers of the one or more packets that are to be considered as discarded, not expected, considered as delivered to an upper layer, or considered as received.

A10-1. The method of any of embodiments A1-A8, wherein the signaling is included in a data packet with a sequence number, wherein the receiver is to consider as discarded, not expect, consider as delivered to an upper layer, or consider as received each packet that has a sequence number less than the sequence number of the data packet.

A11. The method of any of embodiments A1-A8, wherein the signaling does not explicitly indicate which one or more packets are to be considered as discarded, not expected, considered as delivered to an upper layer, or considered as received.

A12. The method of embodiment A11, wherein the receiver is to consider as discarded, not expect, consider as delivered to an upper layer, or consider as received each packet that, as of receipt of the signaling, is within a reordering window of the receiver.

A13. The method of any of embodiments A1-A12, further comprising making a decision as to whether or not to transmit the signaling.

A14. The method of embodiment A13, further comprising estimating a delay until a packet would be or will be received by the receiver, and wherein the decision is made based on the estimated delay.

A15. The method of embodiment A14, wherein the delay is a delay until the packet would be or will be received at a PDCP layer or an application layer at the receiver.

A16. The method of any of embodiments A14-A15, wherein said making comprises making the decision to transmit the signaling if the estimated delay exceeds a threshold.

A17. The method of any of embodiments A1-A16, wherein the one or more packets convey data for an extended reality, XR, application.

A18. The method of any of embodiments A1-A17, wherein the transmitter is a wireless device.

A19. The method of any of embodiments A1-A17, wherein the transmitter is a radio network node.

AA. The method of any of the previous embodiments, further comprising:
providing user data; and
forwarding the user data to a host computer via the transmission to a base station.

### Group B Embodiments

B1. A method performed by a receiver configured for use in a wireless communication network, the method comprising:
receiving, from a transmitter, signaling indicating that the receiver is to consider as discarded, not expect, consider as delivered to an upper layer, or consider as received one or more packets.

B2. The method of embodiment B1, wherein the transmitter is a Packet Data Convergence Protocol, PDCP, transmitter, the receiver is a PDCP receiver, and the one or more packets are one or more PDCP packets.

B3. The method of any of embodiments B1-B2, wherein the signaling is or is included in a PDCP packet.

B4. The method of any of embodiments B1-B3, wherein the signaling is or is included in a PDCP control protocol data unit, PDU.

B5. The method of embodiment B4, wherein the PDCP control PDU is a type of PDCP control PDU dedicated or specific for indicating that the receiver is to consider as discarded, not expect, consider as delivered to an upper layer, or consider as received one or more packets.

B6. The method of any of embodiments B1-B3, wherein the signaling is or is included in a PDCP data PDU.

B7. The method of embodiment B6, wherein the PDCP data PDU includes a field that indicates the receiver is to consider as discarded, not expect, consider as delivered to an upper layer, or consider as received one or more packets.

B8. The method of embodiment B6, wherein the PDCP data PDU includes a field that indicates whether one or more sequence numbers indicated by the PDCP data PDU are one or more respective sequence numbers of one or more packets that the receiver is to consider as discarded, not expect, consider as delivered to an upper layer, or consider as received.

B9. The method of any of embodiments B1-B8, wherein the signaling indicates which one or more packets are to be considered as discarded, not expected, considered as delivered to an upper layer, or considered as received by explicitly indicating each of one or more respective sequence numbers of the one or more packets.

B10. The method of any of embodiments B1-B8, wherein the signaling indicates which one or more packets are to be considered as discarded, not expected, considered as delivered to an upper layer, or considered as received by explicitly indicating a sequence number of a packet having the highest sequence number among one or more respective sequence numbers of the one or more packets that are to be considered as discarded, not expected, considered as delivered to an upper layer, or considered as received.

B10-1. The method of any of embodiments B1-B8, wherein the signaling is included in a data packet with a sequence number, wherein the receiver is to consider as discarded, not expect, consider as delivered to an upper layer, or consider as received each packet that has a sequence number less than the sequence number of the data packet.

B11. The method of any of embodiments B1-B8, wherein the signaling does not explicitly indicate which one or more packets are to be considered as discarded, not expected, considered as delivered to an upper layer, or considered as received.

B12. The method of embodiment B11, wherein the receiver is to consider as discarded, not expect, consider as delivered to an upper layer, or consider as received each packet that, as of receipt of the signaling, is within a reordering window of the receiver.

B13. The method of any of embodiments B1-B12, further comprising, based on the signaling, considering the one or more packets as discarded, as delivered to an upper layer, or as received.

B14. The method of any of embodiments B1-B13, further comprising, based on the signaling, updating one or more parameters at the receiver to reflect that the one or more packets are not expected, that the one or more packets have been received, that the one or more packets have been discarded, and/or that the one or more packets have been delivered to an upper layer.

B15. The method of embodiment B14, wherein the one or more parameters include an RX_DELIV parameter indicating a sequence number of a next packet to be delivered to an upper layer.

B16. The method of any of embodiments B1-B15, wherein the one or more packets convey data for an extended reality, XR, application.

B17. The method of any of embodiments B1-B16, wherein the transmitter is a wireless device.

B18. The method of any of embodiments B1-B16, wherein the transmitter is a radio network node.

B19. The method of any of embodiments B1-B18, further comprising, based on the signaling, updating a reordering window at the receiver.

B20. The method of embodiment B19, wherein the reordering window is a PDCP reordering window.

B21. The method of any of embodiments B1-B20, further comprising:
waiting to receive the one or more packets; and
responsive to receiving the signaling, stopping waiting to receive the one or more packets.

BB. The method of any of the previous embodiments, further comprising:
obtaining user data; and
forwarding the user data to a host computer or a wireless device.

### Group C Embodiments

C1. A transmitter configured to perform any of the steps of any of the Group A embodiments.

C2. A transmitter comprising processing circuitry configured to perform any of the steps of any of the Group A embodiments.

C3. A transmitter comprising:
communication circuitry; and
processing circuitry configured to perform any of the steps of any of the Group A embodiments.

C4. A transmitter comprising:
processing circuitry configured to perform any of the steps of any of the Group A embodiments; and
power supply circuitry configured to supply power to the transmitter.

C5. A transmitter comprising:
processing circuitry and memory, the memory containing instructions executable by the processing circuitry whereby the transmitter is configured to perform any of the steps of any of the Group A embodiments.

C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A or Group B embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C7. A computer program comprising instructions which, when executed by at least one processor of a transmitter, causes the transmitter to carry out the steps of any of the Group A embodiments.

C8. A carrier containing the computer program of embodiment C7, wherein the carrier is one of an electronic signal, optical signal, radio signal, or computer readable storage medium.

C9. A receiver configured to perform any of the steps of any of the Group B embodiments.

C10. A receiver comprising processing circuitry configured to perform any of the steps of any of the Group B embodiments.

C11. A receiver comprising:
communication circuitry; and
processing circuitry configured to perform any of the steps of any of the Group B embodiments.

C12. A receiver comprising:
processing circuitry configured to perform any of the steps of any of the Group B embodiments;
power supply circuitry configured to supply power to the receiver.

C13. A receiver comprising:
processing circuitry and memory, the memory containing instructions executable by the processing circuitry whereby the receiver is configured to perform any of the steps of any of the Group B embodiments.

C14. A computer program comprising instructions which, when executed by at least one processor of a receiver, causes the receiver to carry out the steps of any of the Group B embodiments.

C15. A carrier containing the computer program of embodiment C14, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group A or Group B embodiments.

D2. The communication system of the previous embodiment further including the base station.

D3. The communication system of the previous 2 embodiments, further including the UE, wherein the UE is configured to communicate with the base station.

D4. The communication system of the previous 3 embodiments, wherein:
the processing circuitry of the host computer is configured to execute a host application, thereby providing the user data; and
the UE comprises processing circuitry configured to execute a client application associated with the host application.

D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group A or Group B embodiments.

D6. The method of the previous embodiment, further comprising, at the base station, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with a base station, the UE comprising a radio interface and processing circuitry configured to perform any of the previous 3 embodiments.

D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

D10. The communication system of the previous embodiment, wherein the cellular network further includes a base station configured to communicate with the UE.

D11. The communication system of the previous 2 embodiments, wherein:
the processing circuitry of the host computer is configured to execute a host application, thereby providing the user data; and
the UE's processing circuitry is configured to execute a client application associated with the host application.

D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A or Group B embodiments.

D13. The method of the previous embodiment, further comprising at the UE, receiving the user data from the base station.

D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A or Group B embodiments.

D15. The communication system of the previous embodiment, further including the UE.

D16. The communication system of the previous 2 embodiments, further including the base station, wherein the base station comprises a radio interface configured to communicate with the UE and a communication interface configured to forward to the host computer the user data carried by a transmission from the UE to the base station.

D17. The communication system of the previous 3 embodiments, wherein:
the processing circuitry of the host computer is configured to execute a host application; and
the UE's processing circuitry is configured to execute a client application associated with the host application, thereby providing the user data.

D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

D19. A method implemented in a communication system including a host computer, a base station and a user equipment (UE), the method comprising:
at the host computer, receiving user data transmitted to the base station from the UE, wherein the UE performs any of the steps of any of the Group A or Group B embodiments.

D20. The method of the previous embodiment, further comprising, at the UE, providing the user data to the base station.

D21. The method of the previous 2 embodiments, further comprising:
at the UE, executing a client application, thereby providing the user data to be transmitted; and
at the host computer, executing a host application associated with the client application.

D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group A or Group B embodiments.

D24. The communication system of the previous embodiment further including the base station.

D25. The communication system of the previous 2 embodiments, further including the UE, wherein the UE is configured to communicate with the base station.

D26. The communication system of the previous 3 embodiments, wherein:
the processing circuitry of the host computer is configured to execute a host application;
the UE is configured to execute a client application associated with the host application, thereby providing the user data to be received by the host computer.

D27. A method implemented in a communication system including a host computer, a base station and a user equipment (UE), the method comprising:

at the host computer, receiving, from the base station, user data originating from a transmission which the base station has received from the UE, wherein the UE performs any of the steps of any of the Group A or Group B embodiments.

D28. The method of the previous embodiment, further comprising at the base station, receiving the user data from the UE.

D29. The method of the previous 2 embodiments, further comprising at the base station, initiating a transmission of the received user data to the host computer.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1×Radio Transmission Technology
3GPP 3rd Generation Partnership Project
5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDUCommon Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1. A method performed by a receiver configured for use in a wireless communication network, the method comprising:
waiting to receive one or more packets from a transmitter;
receiving, from the transmitter, signaling indicating that the receiver to consider the one or more packets as discarded, not expect the one or more packets, consider the one or more packets as delivered to an upper layer, or consider the one or more packets as received; and
responsive to receiving the signaling, stopping waiting to receive the one or more packets.

2. The method of claim 1, wherein the signaling indicates which one or more packets are to be considered as discarded, not expected, considered as delivered to an upper layer, or considered as received by explicitly indicating:
each of one or more respective sequence numbers of the one or more packets; or
a sequence number of a packet having the highest sequence number among one or more respective sequence numbers of the one or more packets that are to be considered as discarded, not expected, considered as delivered to an upper layer, or considered as received.

3. The method of claim 1, wherein the signaling is included in a data packet with a sequence number, wherein the receiver is to consider as discarded, not expect, consider as delivered to an upper layer, or consider as received each packet that has a sequence number less than the sequence number of the data packet.

4. The method of claim 1, wherein the signaling does not explicitly indicate which one or more packets are to be considered as discarded, not expected, considered as delivered to an upper layer, or considered as received, wherein the receiver is to consider as discarded, not expect, consider as delivered to an upper layer, or consider as received each packet that, as of receipt of the signaling, is within a reordering window of the receiver.

5. The method of claim 1, wherein the transmitter is a Packet Data Convergence Protocol, PDCP, transmitter, the receiver is a PDCP receiver, and the one or more packets (14-X) are one or more PDCP packets.

6. The method of claim 1, wherein the signaling is or is included in a PDCP packet.

7. The method of claim 1, wherein the signaling is or is included in a PDCP control protocol data unit, PDU, wherein the PDCP control PDU is a type of PDCP control PDU dedicated or specific for indicating that the receiver is to consider the one or more packets as discarded, not expect the one or more packets, consider the one or more packets as delivered to an upper layer, or consider the one or more packets as received.

8. The method of claim 1, wherein the signaling is or is included in a PDCP data PDU, wherein the PDCP data PDU includes either:
a field that indicates the receiver is to consider the one or more packets as discarded, not expect the one or more packets, consider the one or more packets as delivered to an upper layer, or consider the one or more packets as received; or
a field that indicates whether one or more sequence numbers indicated by the PDCP data PDU are one or more respective sequence numbers of one or more packets that the receiver is to consider as discarded, not expect, consider as delivered to an upper layer, or consider as received.

9. The method of claim 1, further comprising, based on the signaling, considering the one or more packets as discarded, as delivered to an upper layer, or as received.

10. The method of claim 1, further comprising, based on the signaling, updating one or more parameters at the receiver to reflect that the one or more packets are not expected, that the one or more packets have been received, that the one or more packets have been discarded, and/or that the one or more packets have been delivered to an upper layer.

11. The method of claim 10, wherein the one or more parameters include an RX_DELIV parameter indicating a sequence number of a next packet to be delivered to an upper layer.

12. The method of claim 1, further comprising, based on the signaling, updating a reordering window at the receiver.

13. The method of claim 1, wherein said waiting comprises waiting to receive the one or more packets while a reordering timer is running, and wherein said stopping comprises, responsive to receiving the signaling while the reordering timer is running, stopping waiting to receive the one or more packets before the reordering timer expires.

14. A method performed by a transmitter configured for use in a wireless communication network, the method comprising:
transmitting, to a receiver, signaling indicating that the receiver is to consider one or more packets as discarded, not expect one or more packets, consider one or more packets as delivered to an upper layer, or consider one or more packets as received.

15. The method of claim 14, wherein the signaling is included in a data packet with a sequence number, wherein the receiver is to consider as discarded, not expect, consider as delivered to an upper layer, or consider as received each packet that has a sequence number less than the sequence number of the data packet.

16. The method of claim 14, wherein the signaling does not explicitly indicate which one or more packets are to be considered as discarded, not expected, considered as delivered to an upper layer, or considered as received, wherein the receiver is to consider as discarded, not expect, consider as delivered to an upper layer, or consider as received each packet that, as of receipt of the signaling, is within a reordering window of the receiver.

17. The method of claim 14, wherein the transmitter is a Packet Data Convergence Protocol, PDCP, transmitter, the receiver is a PDCP receiver, and the one or more packets are one or more PDCP packets.

18. The method of claim 14, wherein the signaling is or is included in a PDCP packet.

19.-23. (canceled)

24. A receiver configured for use in a wireless communication network, the receiver configured to:
wait to receive one or more packets from a transmitter;
receive, from the transmitter, signaling indicating that the receiver is to consider the one or more packets as discarded, not expect the one or more packets, consider the one or more packets as delivered to an upper layer, or consider the one or more packets as received; and
responsive to receiving the signaling, stop waiting to receive the one or more packets.

25. (canceled)

26. A transmitter configured for use in a wireless communication network, the transmitted configured to:
transmit, to a receiver, signaling indicating that the receiver is to consider one or more packets as discarded, not expect one or more packets, consider one or more packets as delivered to an upper layer, or consider one or more packets as received one or more packets.

27.-30. (canceled)
